(19) United States
(12) Patent Application Publication
(10) Pub. No.: US 2025/0336355 A1
(43) Pub. Date: Oct. 30, 2025

(54) DISPLAY APPARATUS, PHOTOELECTRIC CONVERSION APPARATUS, AND ELECTRONIC APPARATUS

(71) Applicant: CANON KABUSHIKI KAISHA, Tokyo (JP)

(72) Inventors: RYUSEI KUSUHARA, Tokyo (JP); SHINTARO MAEKAWA, Kanagawa (JP); FUMIHIRO INUI, Kanagawa (JP); TETSURO YAMAMOTO, Kanagawa (JP); TAKASHI MUTO, Kanagawa (JP); TAKAHIRO AKIYAMA, Kanagawa (JP); AKIHITO KOMAZAWA, Kanagawa (JP)

(21) Appl. No.: 19/175,541

(22) Filed: Apr. 10, 2025

(30) Foreign Application Priority Data
Apr. 30, 2024 (JP) 2024-073803

(51) Int. Cl. G09G 3/3233; H04N 23/63

(52) U.S. Cl. CPC G09G 3/3233; H04N 23/63; G09G 2300/0861; G09G 2310/08; G09G 2320/0252; G09G 2320/045; G09G 2340/0407

(57) ABSTRACT

A display apparatus includes a display area including pixels arranged in a matrix, the pixels including a light emitting element, a write control transistor, a light emission control transistor, and a drive transistor; a first selection line for each row of the pixels and connected to the write control transistors; a second selection line for each row of the pixels and connected to the light emission control transistors; a first scanning circuit which scans the first selection lines; and a second scanning circuit which scans the second selection lines. Image data displayed in the display area is divided into regions having different resolutions, a speed of scanning by the first scanning circuit is different for each region, and a speed of scanning by the second scanning circuit is a lowest speed of the speed of scanning by the first scanning circuit and less than a maximum speed thereof.

### BACKGROUND OF THE INVENTION

### Field of the Invention

The present invention relates to a display apparatus, a photoelectric conversion apparatus, and an electronic apparatus.

### Description of the Related Art

As the number of pixels is increased and the frame rate is increased in display apparatuses, an amount of image data increases. For this reason, a technique is known in which a central portion of a display region of a display apparatus, where a user's viewpoint is more likely to be directed, is displayed with a high resolution, and regions other than the central portion, where the user's viewpoint is less likely to be directed, are displayed with a low resolution.

Japanese Patent Application Publication No. 2010-107582 discloses a technique in which regions other than the central portion are displayed with a low resolution by writing the same signal to a plurality of pixels in the display region.

However, according to the above technique, in the display apparatus in which the same signal is written to a plurality of pixels, an amount of current flowing through a light emitting element is biased in time due to a light emission area of the display region being biased in time, and thus, there is a possibility of causing degradation in display quality.

### SUMMARY OF THE INVENTION

In this regard, the present invention has been made in view of the above, and an object of the present invention is to suppress degradation in display quality in a display apparatus in which signals are written to a plurality of pixels.

According to some embodiments, a display apparatus includes a display area including a plurality of pixels arranged in a matrix, the pixels each including a light emitting element, a write control transistor for writing a signal voltage to the light emitting element, a light emission control transistor for causing the light emitting element to emit light, and a drive transistor for driving the light emitting element, a first selection line which is provided for each row of the plurality of pixels and connected to the write control transistors of the pixels arranged in a row direction, a second selection line which is provided for each row of the plurality of pixels and connected to the light emission control transistors of the pixels arranged in the row direction, a first scanning circuit which scans a plurality of the first selection lines in sequence, a second scanning circuit which scans a plurality of the second selection lines in sequence, wherein image data is displayed in the display area, the image data is divided into a plurality of regions having different resolutions, and the plurality of regions are arranged such that at least two regions are included in a column direction, a speed of scanning by the first scanning circuit is different for each of the regions arranged in the column direction, and a speed of scanning by the second scanning circuit is at least a lowest speed of the speed of scanning by the first scanning circuit and less than a maximum speed thereof.

Further features of the present invention will become apparent from the following description of exemplary embodiments with reference to the attached drawings.

### BRIEF DESCRIPTION OF THE DRAWINGS

FIG. 1 is a diagram illustrating an example of a configuration of a display apparatus according to a first embodiment.

FIG. 2 is a diagram illustrating an example of a configuration of a pixel drive circuit according to the first embodiment.

FIG. 3A is a diagram schematically illustrating control of writing and light emission in the display apparatus according to the prior art.

FIG. 3B is a diagram schematically illustrating control of writing and light emission in the display apparatus according to the prior art.

FIG. 3C is a diagram schematically illustrating control of writing and light emission in the display apparatus according to the first embodiment.

FIG. 3D is a diagram schematically illustrating control of writing and light emission in the display apparatus according to a modification.

FIG. 3E is a diagram schematically illustrating control of writing and light emission in the display apparatus according to the prior art.

FIG. 3F is a diagram schematically illustrating control of writing and light emission in the display apparatus according to the first embodiment.

FIG. 3G is a diagram schematically illustrating control of writing and light emission in the display apparatus according to a modification.

FIG. 4 is a diagram illustrating an example of a configuration of a vertical scanning circuit according to the first embodiment.

FIG. 5 is an operation timing chart of the vertical scanning circuit according to the first embodiment.

FIG. 6 is an operation timing chart of the vertical scanning circuit according to a modification.

FIG. 7 is an operation timing chart of the vertical scanning circuit according to a modification.

FIG. 8 is an operation timing chart of the vertical scanning circuit according to a modification.

FIG. 9 is a diagram schematically illustrating a relationship between an image signal and a display image in the first embodiment.

FIG. 10 is a diagram illustrating an example of a configuration of the vertical scanning circuit according to a modification.

FIG. 11 is an operation timing chart of the vertical scanning circuit according to a modification.

FIG. 12 is a diagram illustrating an example of a configuration of the vertical scanning circuit according to a modification.

FIG. 13 is an operation timing chart of the vertical scanning circuit according to a modification.

FIGS. 14A and 14B are diagrams illustrating an example of a configuration of the vertical scanning circuit according to a modification.

FIG. 15 is a diagram illustrating an example of a configuration of the display apparatus according to the second embodiment.

FIG. 16 is a diagram illustrating an example of a configuration of the vertical scanning circuit according to the second embodiment.

FIG. 17 is an operation timing chart of the vertical scanning circuit according to the second embodiment.

FIG. 18 is a diagram illustrating an example of a configuration of the vertical scanning circuit according to a modification.

FIG. 19 is a diagram illustrating an example of a configuration of the pixel drive circuit according to a modification.

FIG. 20 is a diagram illustrating an example of a configuration of the pixel drive circuit according to a modification.

FIG. 21 is an operation timing chart of the vertical scanning circuit according to a modification.

FIG. 22 is a diagram schematically illustrating a relationship between an image signal and a display image in the second embodiment.

FIG. 23 is a cross-sectional view illustrating an example of a part of the display apparatus according to an embodiment.

FIG. 24 is a schematic cross-sectional view illustrating an example of the display apparatus according to an embodiment.

FIG. 25 is a schematic view illustrating an example of a display component according to a third embodiment.

FIGS. 26A and 26B are schematic views illustrating an example of an imaging apparatus according to fourth and fifth embodiments.

FIGS. 27A and 27B are schematic views illustrating an example of an image display apparatus according to a sixth embodiment.

FIGS. 28A and 28B are schematic views illustrating an application example of the display apparatus according to a seventh embodiment.

FIGS. 29A and 29B are schematic views illustrating an application example of the display apparatus according to an eighth embodiment.

### DESCRIPTION OF THE EMBODIMENTS

### First Embodiment

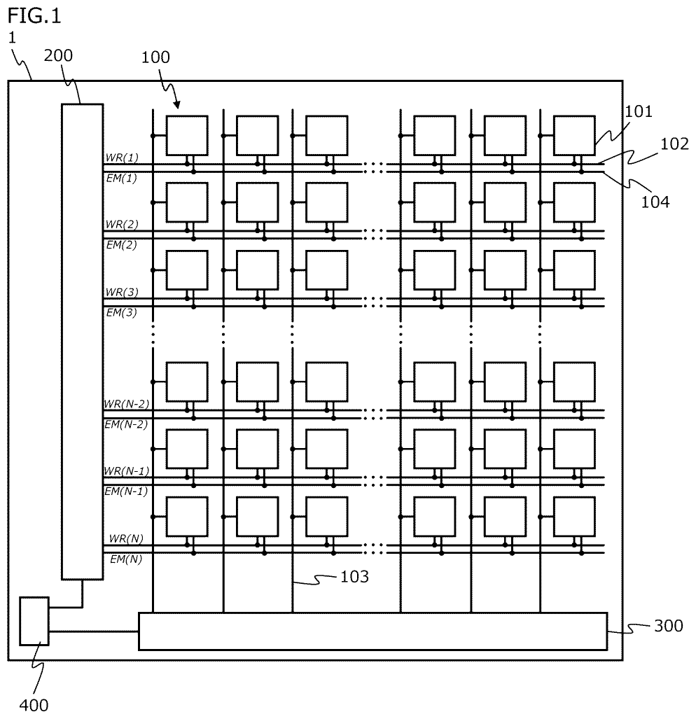

A display apparatus according to a first embodiment of the present invention will be described below with reference to the accompanying drawings. FIG. 1 is a schematic diagram illustrating an example of a configuration of the display apparatus 1 according to the present embodiment. The display apparatus 1 includes a pixel array 100, a vertical scanning circuit 200, a signal output circuit 300, and a control circuit 400. The pixel array 100 is a display area including a plurality of pixels arranged in a matrix, and has a plurality of unit pixel drive circuits 101 arranged two-dimensionally over a plurality of rows and a plurality of columns. Each unit pixel drive circuit 101 includes a light emitting element, such as an organic EL element, and a transistor for controlling writing and light emission of an image signal. In the present embodiment, it is assumed that the unit pixel drive circuit 101 corresponds to a pixel, but in order to achieve an operation of the display apparatus 1 described below, the pixels may include components other than the unit pixel drive circuit 101 as appropriate. In addition, in FIG. 1, other unit pixel drive circuits having the same shape as that of the unit pixel drive circuit 101 are also configured in a manner similar to that of the unit pixel drive circuit 101. In this way, in the display apparatus 1 according to the first embodiment, a plurality of pixel drive circuits in the display area are uniform in size.

The unit pixel drive circuit 101 is connected to the vertical scanning circuit 200 via a write selection line 102 and a light emission selection line 104 provided in common for each row. Further, the unit pixel drive circuit 101 is connected to the signal output circuit 300 via an image signal line 103 provided in common for each column. The signal output circuit 300 is controlled by the control circuit 400 and outputs an individual image signal for each column to the unit pixel drive circuit 101.

On the other hand, the vertical scanning circuit 200 is controlled by a control circuit 400 and selects a row (hereinafter, referred to as a write row) in the pixel array 100 for writing a signal voltage related to an image signal, based on write control signals WR(1) to WR(N) output via the write selection lines 102. Then, the vertical scanning circuit 200 selects a row for emitting light from the light emitting element with brightness corresponding to the written signal voltage, based on light emission control signals EM(1) to EM(N) output via the light emission selection lines 104. Here, N is an integer.

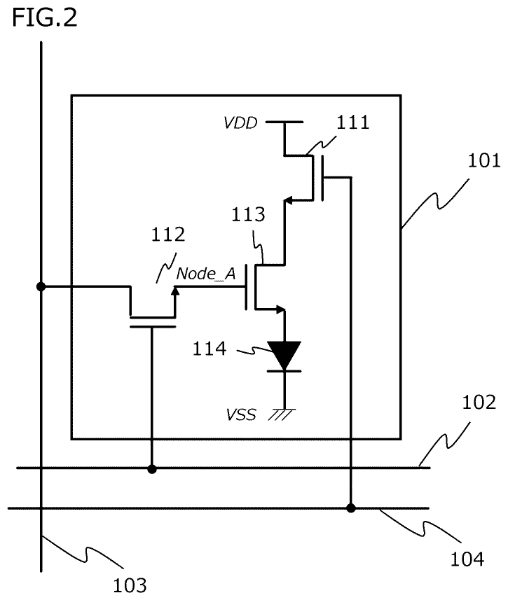

FIG. 2 illustrates an example of a configuration of the unit pixel drive circuit 101 according to the present embodiment. The unit pixel drive circuit 101 includes a light emission control transistor 111, a write control transistor 112, a drive transistor 113, and a light emitting diode 114. A cathode terminal of the light emitting diode 114 is connected to a VSS, which is a ground level, and an anode terminal of the light emitting diode 114 is connected to a source terminal of the drive transistor 113. A drain terminal of the drive transistor 113 is connected to a source terminal of the light emission control transistor 111, and a gate terminal of the drive transistor 113 is connected to a source terminal of the write control transistor 112. A drain terminal of the light emission control transistor 111 is connected to a VDD, which is a power supply, and a gate terminal of the light emission control transistor 111 is connected to the light emission selection line 104. A drain terminal of the write control transistor 112 is connected to the image signal line 103, and a gate terminal of the write control transistor 112 is connected to the write selection line 102. In the present embodiment, the write selection line 102 is a first selection line which is provided for each row of the plurality of unit pixel drive circuits 101 and is connected to the write control transistors of the unit pixel drive circuits 101 arranged in a row direction. In addition, the light emission selection line 104 is a second selection line which is provided for each row of the plurality of unit pixel drive circuits 101 and is connected to the light emission control transistors of the unit pixel drive circuits 101 arranged in the row direction.

Next, an example of an operation of the unit pixel drive circuit 101 will be described. When the write selection line 102 becomes an ON level (hereinafter referred to as “H level”), the write control transistor 112 is turned ON. Then, the signal voltage related to the image signal supplied from the image signal line 103 is written into Node_A to which the gate terminal of the drive transistor 113 is connected. Next, when the write selection line 102 becomes an OFF level (hereinafter referred to as “L level”), the write control transistor 112 is turned OFF, and the signal voltage is held in a parasitic capacitance of the Node_A. In the present embodiment, examples of the parasitic capacitance of the Node_A may include an inter-line capacitance, a parasitic capacitance between the gate terminal and the source terminal of the drive transistor 113, a parasitic capacitance between the gate terminal and the drain terminal, and the like. Thereafter, the light emission selection line 104 becomes the H level, and the light emission control transistor 111 is turned ON. Then, a current corresponding to the signal voltage held in the Node A to which the gate terminal of the drive transistor 113 is connected is supplied to the light emitting diode 114, and the light emitting diode 114 emits light.

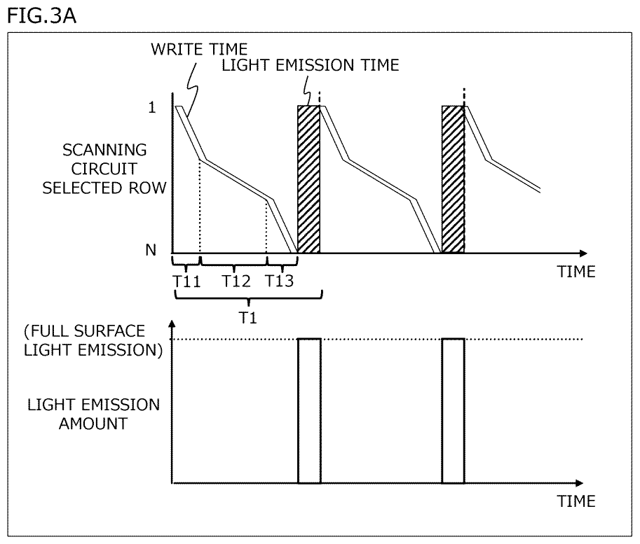

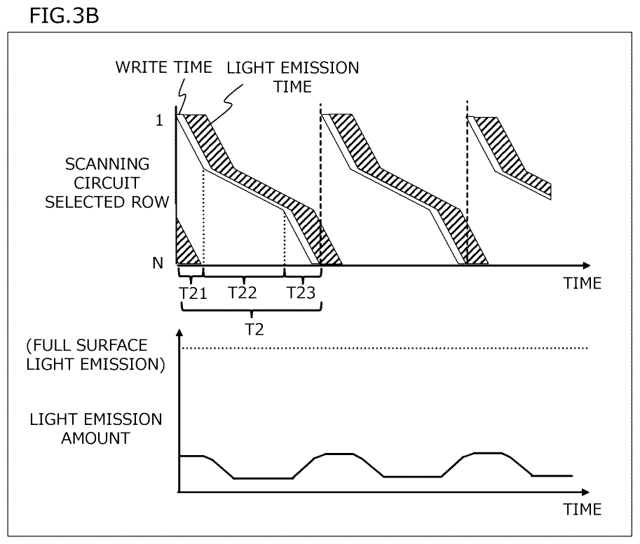

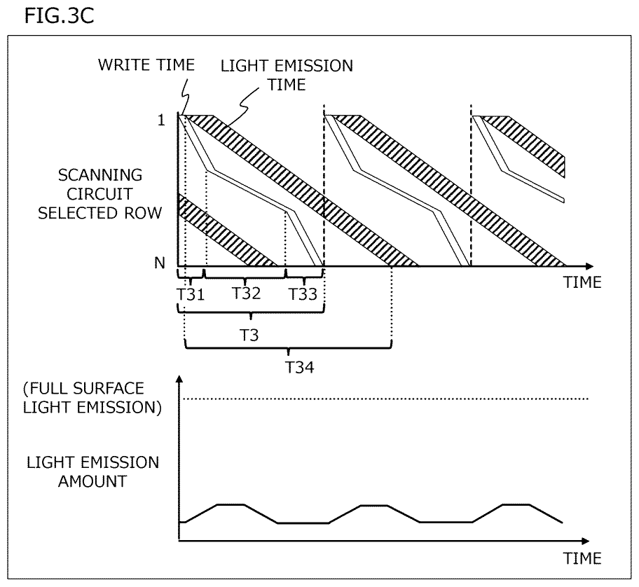

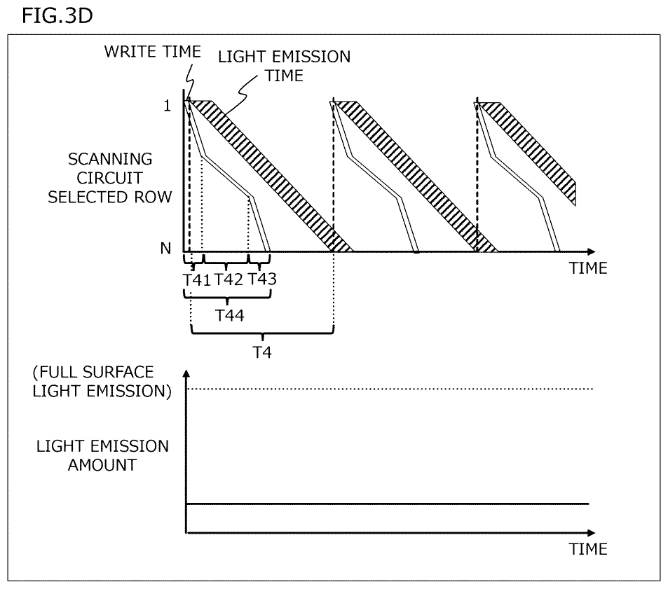

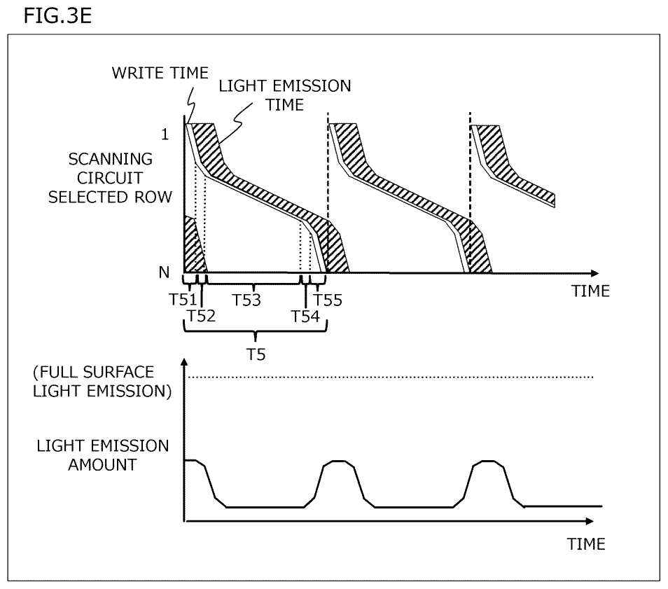

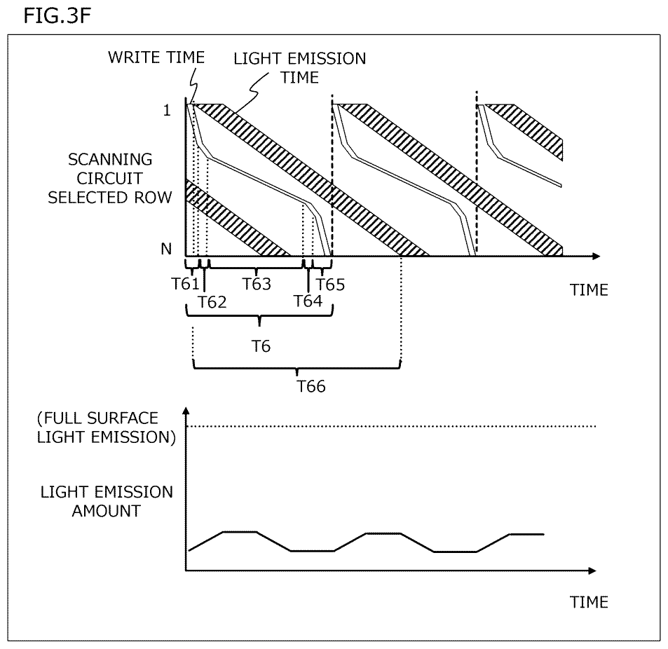

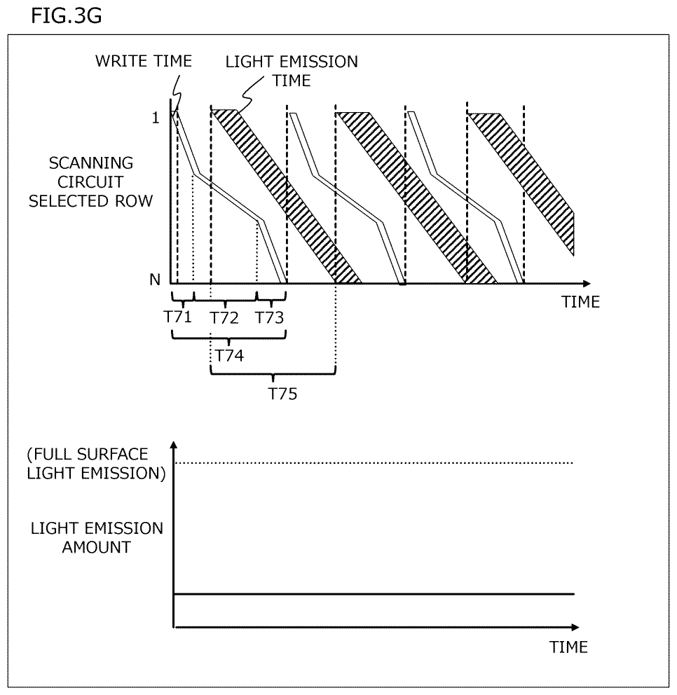

Here, a control of signal voltage writing and light emission in a conventional display apparatus that performs an operation of writing the same image signal to a plurality of pixels in a display region will be described with reference to FIGS. 3A and 3B. Note that in the conventional display apparatus, arrangement of the write selection line, the light emission selection line, and the vertical scanning circuit is similar to that of the above-described display apparatus 1. In addition, in the following description, the display area of the display apparatus displays image data, the image data is divided into a plurality of regions having different resolutions, and the plurality of regions are arranged such that at least two or more regions are included in a column direction. In addition, it is also assumed that each of a speed of scanning by a write scanning circuit and a speed of scanning by a light emission scanning circuit is given by “(a sum of intervals of selection lines in a region)/(a time required for scanning the region)”.

In the conventional display apparatus, light emission Duty control is performed in which a certain light emitting element emits light only for a limited period of one frame period. FIG. 3A is a graph illustrating a relationship between a write time, a light emission time, and an amount of light emission in a pixel array according to a control method for the signal voltage writing and the light emission in the display apparatus disclosed in Japanese Patent Application Publication No. 2010-107582. As illustrated in FIG. 3A, in this control method, after signal voltages are written to all pixel drive circuits in high-resolution regions and low-resolution regions constituting the display region, all pixels are caused to emit light all at once (full-surface light emission). In FIG. 3A, in a period T1 of one frame, a period T11 and a period T13 are periods for writing signal voltages to the pixel drive circuits in the low-resolution region, and a period T12 is a period for writing signal voltages to the pixel drive circuits in the high-resolution region. In this control method, the light emission of the display region is biased in time within the period T1 of one frame, so that the amount of current flowing through the light emitting element is also biased in time, resulting in degradation in display quality.

In addition, FIG. 3B is a graph illustrating the relationship between the write time, the light emission time, and the amount of light emission in the pixel array according to another control method for the signal voltage writing and the light emission in the conventional display apparatus. As illustrated in FIG. 3B, a control method of performing light emission only for a certain period immediately after writing in each pixel drive circuit can be considered. In FIG. 3B, in a period T2 of one frame, a period T21 and a period T23 are periods for writing signal voltages to the pixel drive circuits in the low-resolution region, and a period T22 is a period for writing signal voltages to the pixel drive circuits in the high-resolution region. This control method can suppress a temporal deviation of the amount of current flowing through the light emitting element during the period T2 of one frame, compared to the control method of FIG. 3A. However, in this control method, there is a possibility that flickering of an image to be displayed or the like occurs due to a difference in light emission scanning speed between the periods T21 and T23 and the period T22.

In addition, FIG. 3E is a graph illustrating the relationship between the write time, the light emission time, and the amount of light emission in the pixel array according to another control method for the signal voltage writing and the light emission in the conventional display apparatus. In FIG. 3E, in a period T5 of one frame, a period T51 and a period T55 are periods for writing signal voltages to the pixel drive circuits in the low-resolution region. In addition, a period T52 and a period T54 are periods for writing signal voltages to the pixel drive circuits in a medium-resolution region. In addition, the period T53 is a period for writing signal voltages to the pixel drive circuits in the high-resolution region. In FIG. 3E, the number of pixel drive circuits to which signal voltages are written simultaneously in the low-resolution region is greater than the number of pixel drive circuits to which signal voltages are written simultaneously in the low-resolution region in FIGS. 3A and 3B. In this way, when the conventional control method is employed in the case where the number of pixel drive circuits to which signal voltages are written simultaneously increases, there is a possibility that the flickering of an image to be displayed or the like occurs due to a difference in light emission scanning speed between periods in respective resolution regions. Further, an amount of light emission in the low-resolution region becomes greater than that in FIG. 3B, and the temporal deviation of the current flowing through the light emitting element becomes greater than that in FIG. 3B.

Next, a control method for the signal voltage writing and the light emission in the display apparatus 1 according to the present embodiment will be described. FIG. 3C is a graph illustrating the relationship between the write time, the light emission time, and the amount of light emission in the pixel array according to an example of the control method for the signal voltage writing and the light emission in the display apparatus 1. In FIG. 3C, the scanning speed of the signal voltage writing to each pixel drive circuit differs between the low-resolution region and the high-resolution region, as in FIGS. 3A and 3B. In a period T3 of one frame, a period T31 and a period T33 are periods for writing signal voltages to the pixel drive circuits in the low-resolution region, and a period T32 is a period for writing signal voltages to the pixel drive circuits in the high-resolution region. However, in the display apparatus 1, the scanning speed by the vertical scanning circuit 200 in light emission of the light emitting element is constant in the period T3 of one frame. With this control, the temporal deviation of the amount of current flowing through the light emitting element can be suppressed as compared with the case of FIG. 3A. In addition, with this control, the flickering of the display image due to the change in the light emission scanning speed can be prevented as compared with the case of FIG. 3B.

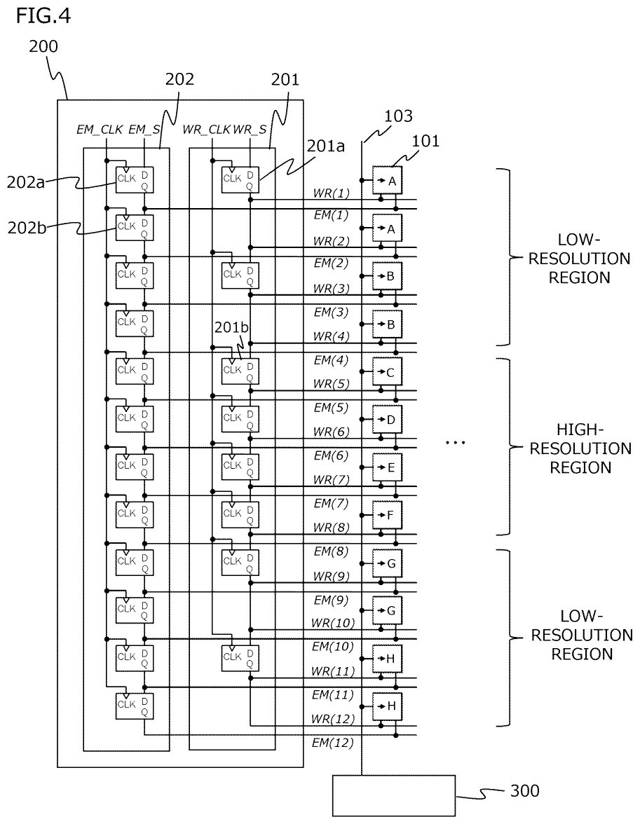

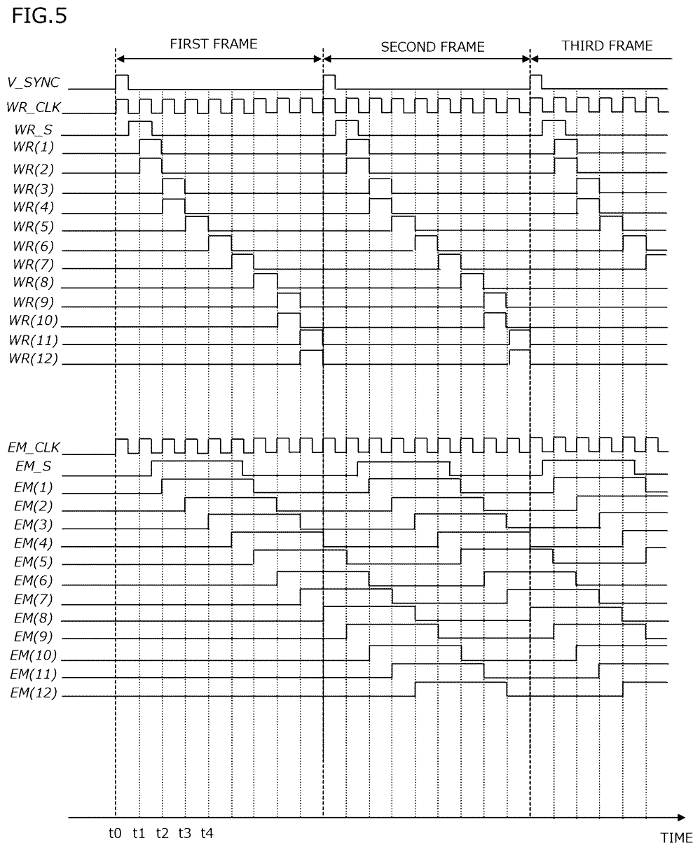

Next, the configuration of the display apparatus 1 for implementing the control method illustrated in FIG. 3C will be described with reference to FIGS. 4 and 5. FIG. 4 is a diagram illustrating an example of a configuration of the vertical scanning circuit 200 of the display apparatus 1, and FIG. 5 is a diagram illustrating an operation timing which is an example of a drive waveform of the vertical scanning circuit 200.

FIG. 4 illustrates the vertical scanning circuit 200, the signal output circuit 300, and a part of the unit pixel drive circuit 101 in the pixel array 100. The number of N in FIG. 1, which is the number of write selection lines 102 and light emission selection lines 104 in FIG. 1, takes an arbitrary integer value. For example, N=1080 in the case of the full HD standard. FIG. 4 illustrates a circuit in the display apparatus 1 when N=12 in FIG. 1 for the sake of simplicity. As illustrated in FIG. 4, the vertical scanning circuit 200 is constituted by a write scanning circuit 201 and a light emission scanning circuit 202, and the write scanning circuit 201 and the light emission scanning circuit 202 are shift register circuits in which D-Flip Flop circuits are cascade-connected in the column direction of the pixel array 100. In addition, in the drawing, the unit pixel drive circuits 101 connected to write selection lines for transmitting WR(1) to WR(4) and WR(9) to WR(12) and light emission selection lines for transmitting EM(1) to EM(4) and EM(9) to EM(12) belong to low-resolution regions. In addition, in the drawing, the unit pixel drive circuits 101 connected to write selection lines for transmitting WR(5) to WR(8) and light emission selection lines for transmitting EM(5) to EM(8) belong to a high-resolution region. A write start pulse WR_S and a write clock WR_CLK are supplied to the write scanning circuit 201, and a light emission start pulse EM_S and a write clock EM CLK are supplied to the light emission scanning circuit 202.

As illustrated in FIG. 5, V_SYNC becomes the H level at time t0 to start one frame. Here, the write scanning circuit 201 writes signal voltages to two unit pixel drive circuits 101 connected to the same image signal line 103 in the low-resolution region. For example, when WR_CLK becomes the H level at time t1, a D-Flip Flop circuit 201a of a first stage of the write scanning circuit 201 latches the H level of the WR_S, which is an input. Then, the D-Flip Flop circuit 201a outputs the H level to the write selection line for WR(1) transmission and the write selection line for WR(2) transmission. Accordingly, a signal voltage related to an image signal A output from the signal output circuit 300 to the image signal line 103 at time t1 is written in the unit pixel drive circuits 101 arranged in two rows.

In addition, in the high-resolution region, the write scanning circuit 201 performs the signal voltage writing to the unit pixel drive circuits 101 in each row. For example, when the WR_CLK becomes the H level at time t3, a D-Flip Flop circuit 201b at a third stage of the write scanning circuit 201 latches the H level of the write selection line for WR(3) transmission and the write selection line for WR(4) transmission, which are inputs. Then, the D-Flip Flop circuit 201b outputs the H level to the write selection line for WR(5) transmission. Accordingly, a signal voltage related to an image signal C output from the signal output circuit 300 to the image signal line 103 at time t3 is written to the unit pixel drive circuit 101 connected to the write selection line for WR (5) transmission. In this way, the write scanning circuit 201 scans a plurality of write selection lines in sequence, whereby the signal voltages related to the image signal are sequentially written to the unit pixel drive circuits 101 in the low-resolution region and the high-resolution region.

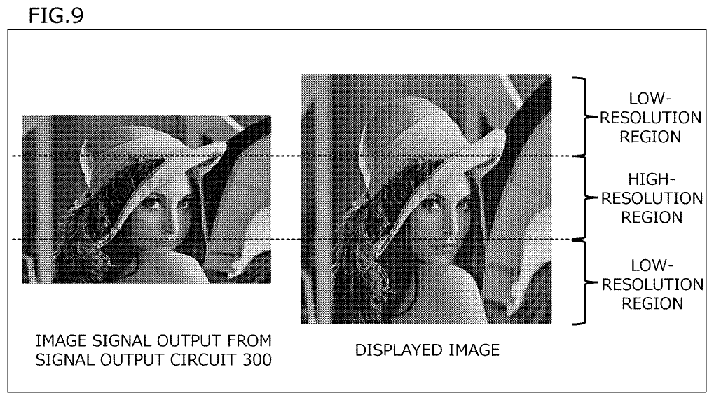

FIG. 9 illustrates an example of a relationship between the image signal output from the signal output circuit 300 and the display image displayed on the pixel array 100 in the signal voltage writing by the display apparatus 1. According to the signal voltage writing by the display apparatus 1 described above, in order to display the display image illustrated in FIG. 9, the image signal output from the signal output circuit 300 has a reduced amount of image data in the low-resolution region in the row direction. Accordingly, the display apparatus 1 can reduce a latency related to image display by sending an externally transmitted image signal from the signal output circuit 300 to the pixel array 100 as it is without expanding the image signal in the control circuit 400 and the signal output circuit 300.

In addition, as for the scanning by the light emission scanning circuit 202 shown in an operation timing chart of FIG. 5, for example, when the EM_CLK becomes the H level at time t2, a D-Flip Flop circuit 202a of a first stage of the light emission scanning circuit 202 latches the H level of the EM_S, which is an input. Then, the D-Flip Flop circuit 202a outputs the H level to the light emission selection line for EM(1) transmission. In addition, when the EM_CLK becomes the H level again at time t4, a D-Flip Flop circuit 202b at a second stage of the light emission scanning circuit 202 latches the H level of the light emission selection line for EM(1) transmission, which is an input, and outputs the H level to the light emission selection line for EM(2) transmission.

In this way, when the light emission scanning circuit 202 scans a plurality of light emission selection lines in sequence, as illustrated in FIG. 3C, in a light emission period T34 of the pixel array 100, light emission of the light emitting elements is sequentially performed at a constant scanning speed regardless of the low-resolution region and the high-resolution region. Accordingly, a change in the light emission area in the pixel array 100 can be suppressed, and a change in the amount of current flowing through the light emitting element can be suppressed. In addition, in the present embodiment, the period T3 of one frame is set to a time required for one scan of the write selection lines 102 of all rows by the write scanning circuit 201. In this way, by defining one frame period in accordance with the write time required for signal voltage writing by the scan of the write scanning circuit 201, it is expected that an efficiency of signal voltage writing to the pixel drive circuit 101 in the display apparatus 1 can be improved.

In addition, in the present embodiment, the speed of scanning by the light emission scanning circuit 202 in the period T34 is at least the speed of scanning by the write scanning circuit 201 in the period T32 and less than the speed of scanning by the write scanning circuit 201 in the period T31 and the period T33. That is, in the display apparatus 1 according to the present embodiment, the light emission scanning speed of the region where the image data of relatively low resolution is displayed is at least the light emission scanning speed of the region where the image data of relatively high resolution is displayed. Then, in the present embodiment, a speed of write scanning by the write scanning circuit 201 is different for each of regions arranged in the column direction of a plurality of regions in which image data with different resolutions in the pixel array 100 are displayed.

Next, in FIG. 3F, a graph is illustrated which, in a case where the write scanning circuit 201 performs the signal voltage writing to the pixel drive circuit for a pixel array having regions of low, medium, and high resolutions, shows a relationship between a write scanning time, a light emission scanning time, and an amount of light emission in the pixel array according to the control method of the present embodiment. Note that the medium-resolution region may be provided appropriately between the low-resolution region and the high-resolution region in the configuration illustrated in FIG. 4.

In FIG. 3F, a period T6 of one frame is set to a time required for one scan of the write selection lines 102 of all rows by the write scanning circuit 201. In addition, in the period T6 of one frame, a period T61 and a period T65 are periods for writing signal voltages to the pixel drive circuits in the low-resolution region. In addition, a period T62 and a period T64 are periods for writing signal voltages to the pixel drive circuits in the medium-resolution region. In addition, a period T63 is a period for writing signal voltages to the pixel drive circuits in the high-resolution region. Further, the speed of scanning by the light emission scanning circuit 202 in the period T66 is at least the speed of scanning by the write scanning circuit 201 in the period T63 and less than the speed of scanning by the write scanning circuit 201 in the period T61 and the period T63. When the light emission scanning circuit 202 performs scanning in this way, it is expected that the display apparatus 1 can efficiently write the signal voltage to the light emitting element while suppressing a change in the amount of current flowing through the light emitting element due to a change in the amount of light emission.

### First Modification

Next, a first modification of the above-described embodiment will be described. Note that in the following description, components similar to those of the display apparatus 1 according to the above-described embodiment are denoted by the same reference numerals, and detailed description of the components and operations will be omitted.

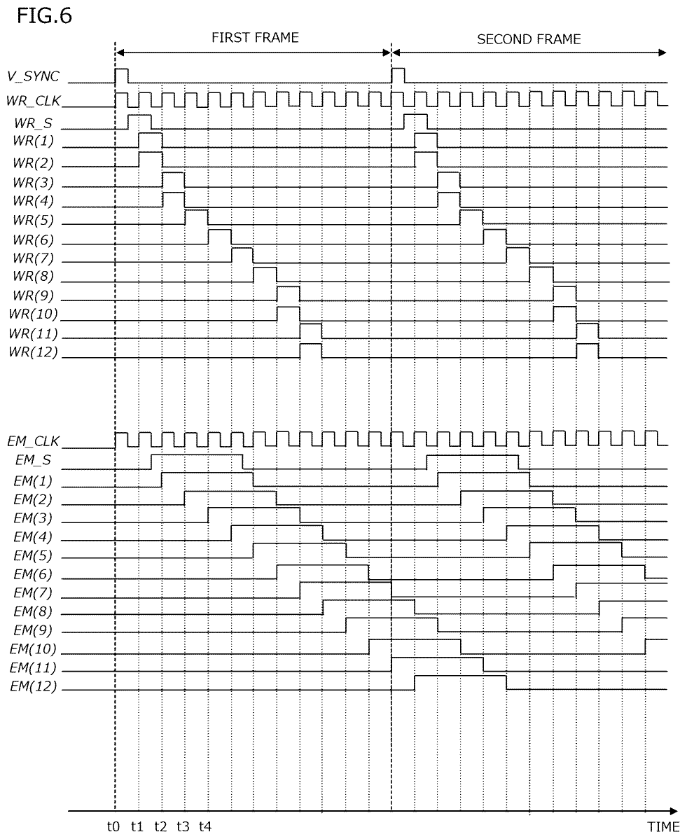

FIG. 6 is a diagram illustrating an operation timing which is an example of the drive waveform of the vertical scanning circuit 200 in this modification. The operation timing chart of FIG. 6 corresponds to the graph illustrated in FIG. 3D. Note that the selection of the write selection line 102 by the write scanning circuit 201 and the selection of the light emission selection line 104 by the light emission scanning circuit 202 shown in the operation timing chart of FIG. 6 are similar to those described above with reference to the operation timing chart of FIG. 5.

In this modification, as shown in FIG. 3D, a period T4 of one frame is set to a time that is defined such that a speed of emission scanning over the light emission selection lines 104 of all rows by the light emission scanning circuit 202 remains constant during the transition to a next frame. Thus, when one frame period is defined according to the light emission time required for light emission by scanning the light emission scanning circuit 202, the light emission area of the pixel array 100 can be kept uniform at any timing in the display apparatus 1.

In addition, in this modification, as illustrated in FIG. 3D, in a period T44, a period T41 and a period T43 are periods for writing signal voltages to the pixel drive circuits in the low-resolution region, a period T42 is a period for writing signal voltages to the pixel drive circuits in the high-resolution region. In addition, the speed of scanning by the light emission scanning circuit 202 in the period T4 of one frame is at least the speed of scanning by the write scanning circuit 201 in the period T42 and less than the speed of scanning by the write scanning circuit 201 in the period T41 and the period T43.

### Second Modification

Next, a second modification of the above-described embodiment will be described. Note that in the following description, components similar to those of the display apparatus 1 according to the above-described embodiment are denoted by the same reference numerals, and detailed description of the components and operations will be omitted.

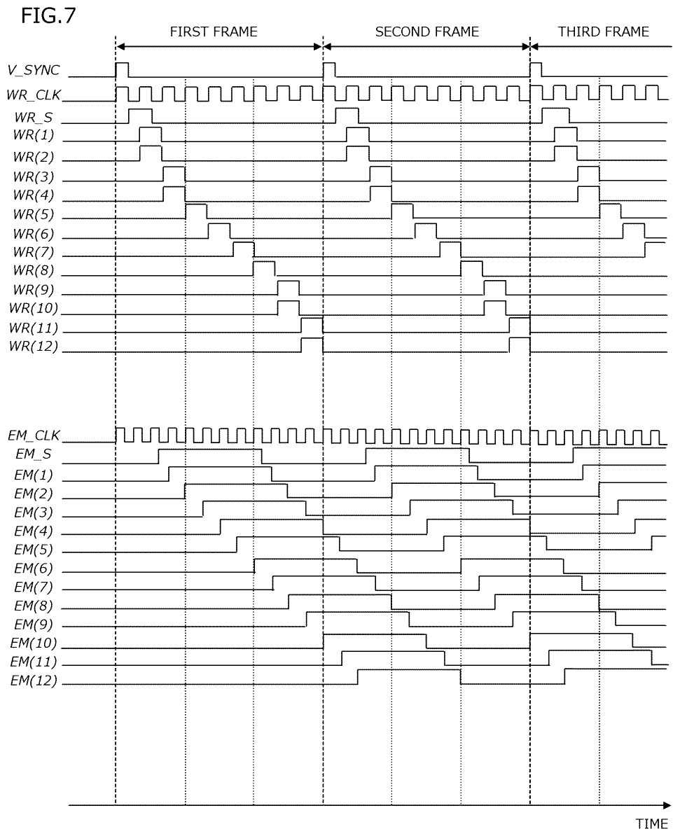

FIG. 7 is a diagram illustrating an operation timing which is an example of the drive waveform of the vertical scanning circuit 200 in this modification. Note that the selection of the write selection line 102 in the scanning by the write scanning circuit 201 shown in the operation timing chart of FIG. 7 and the selection of the light emission selection line 104 in the scanning by the light emission scanning circuit 202 are similar to those described above with reference to the operation timing chart of FIG. 5. However, in FIG. 7, frequencies of the WR_CLK and the EM CLK are different from each other. In addition, in this modification, the period of one frame is set to a time required for one scan of the write selection lines 102 of all rows by the write scanning circuit 201. Further, as illustrated in FIG. 3D, the period T4 of one frame is a time required for one scan of the light emission selection lines 104 of all rows by the light emission scanning circuit 202. Thus, when one frame period is defined according to the light emission time required for light emission by scanning the light emission scanning circuit 202, the light emission area of the pixel array 100 can be kept uniform at any timing in the display apparatus 1. A drive frequency is set by the write scanning circuit 201 and the light emission scanning circuit 202 so as to satisfy the above-described conditions.

In addition, the speed of scanning by the light emission scanning circuit 202 in the period of one frame is at least the speed of scanning by the write scanning circuit 201 for the high-resolution region and less than the speed of scanning by the write scanning circuit 201 for the low-resolution region. Accordingly, in the display apparatus 1 according to this modification, it is possible to end one frame immediately after writing is completed and transition to the next frame while the light emission area of the pixel array 100 is kept uniform at any timing.

### Third Modification

Next, a third modification of the above-described embodiment will be described. Note that in the following description, components similar to those of the display apparatus 1 according to the above-described embodiment are denoted by the same reference numerals, and detailed description of the components and operations will be omitted.

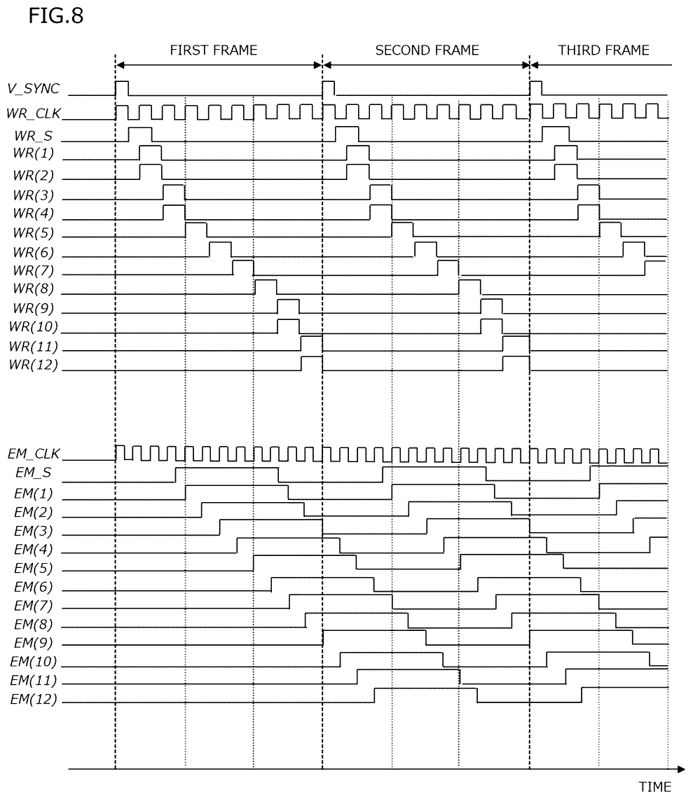

FIG. 8 is a diagram illustrating an operation timing which is an example of the drive waveform of the vertical scanning circuit 200 in this modification. The operation timing chart of FIG. 8 corresponds to the graph illustrated in FIG. 3G. Note that the selection of the write selection line 102 in the scanning by the write scanning circuit 201 shown in the operation timing chart of FIG. 8 and the selection of the light emission selection line 104 in the scanning by the light emission scanning circuit 202 are similar to those described above with reference to the operation timing chart of FIG. 5. However, in FIG. 8, the frequencies of the WR_CLK and the EM_CLK are different from each other.

In addition, in this modification, as illustrated in FIG. 3G, in a period T74, a period T71 of a period T73 are periods for writing signal voltages to the pixel drive circuits in the low-resolution region, a period T72 is a period for writing signal voltages to the pixel drive circuits in the high-resolution region. In addition, a period T75 is a light emission period of the pixel array 100. In this modification, the period of one frame is set to a time required for one scan of the write selection lines 102 of all rows by the write scanning circuit 201. Then, the speed of scanning by the write scanning circuit 201 in the period of one frame is at least the speed of scanning by the write scanning circuit 201 for the high-resolution region and less than the speed of scanning by the write scanning circuit 201 for the low-resolution region.

In addition, as illustrated in FIG. 3G, in the display apparatus 1 according to this modification, light emission is started after a certain time has passed from a write start time. Even if the write start time and a light emission start time do not match, in the display apparatus 1, it is possible to end one frame immediately after writing is completed and transition to the next frame while the light emission area of the pixel array 100 is kept uniform.

### Fourth Modification

Next, a fourth modification of the above-described embodiment will be described. Note that in the following description, components similar to those of the display apparatus 1 according to the above-described embodiment are denoted by the same reference numerals, and detailed description of the components and operations will be omitted.

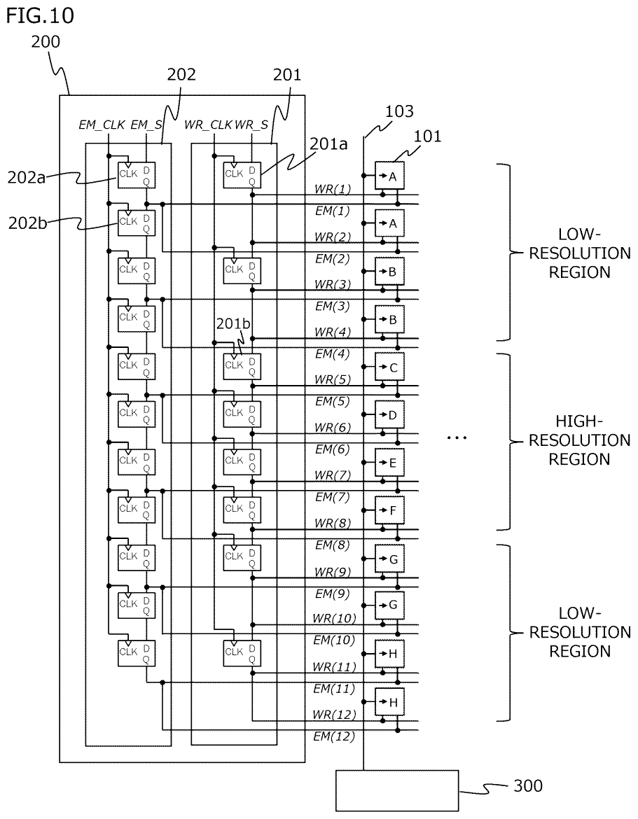

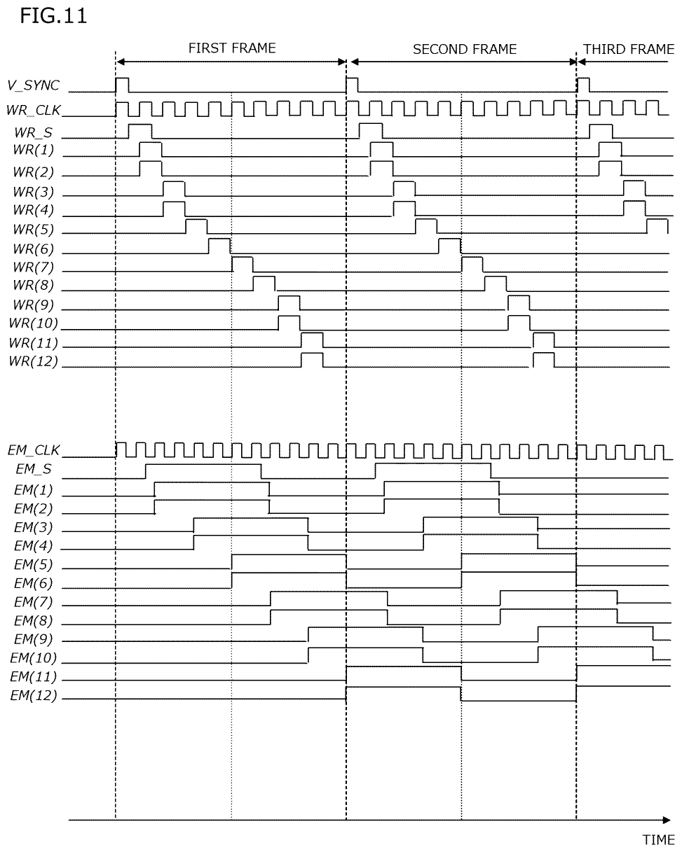

FIG. 10 is a diagram illustrating an example of a configuration of the vertical scanning circuit 200 of the display apparatus 1 according to this modification. FIG. 11 is a diagram illustrating an operation timing which is an example of the drive waveform of the vertical scanning circuit 200 according to this modification. In the vertical scanning circuit 200 illustrated in FIG. 10, a configuration of the write scanning circuit 201 is the same as a configuration of the write scanning circuit 201 illustrated in FIG. 4, but a configuration of the light emission scanning circuit 202 is different from a configuration of the light emission scanning circuit 202 illustrated in FIG. 4. Specifically, for example, one D-Flip Flop circuit 202a is connected with two light emission selection lines (the selection line for EM(1) transmission and the selection line for EM(2) transmission). The D-Flip Flop circuit 202b and the D-Flip Flop circuit at the subsequent stage are also configured similarly. Accordingly, as shown in the operation timing chart of FIG. 11, the display apparatus 1 of this modification performs light emission collectively by the unit pixel drive circuits 101 arranged in two rows and sequentially emits light at a constant scanning speed. Note that the light emission scanning circuit 202 may be configured to perform light emission collectively by the unit pixel drive circuits 101 arranged in at least three rows.

Therefore, even in a case where the display apparatus 1 performs light emission collectively by the unit pixel drive circuits 101 arranged in a plurality of rows, the speed of scanning by the write scanning circuit 201 is not uniform for each of a plurality of regions where image data with different resolutions in the pixel array 100 are displayed. In addition, the speed of scanning by the light emission scanning circuit 202 over the plurality of regions is at least the lowest speed of scanning by the write scanning circuit 201 and less than the highest speed thereof. In this way, by controlling the speed of scanning by the write scanning circuit 201 and the speed of scanning by the light emission scanning circuit 202, it is expected that the efficiency of signal voltage writing to the unit pixel drive circuit 101 can be improved while the light emission area is kept uniform.

### Fifth Modification

Next, a fifth modification of the above-described embodiment will be described. Note that in the following description, components similar to those of the display apparatus 1 according to the above-described embodiment are denoted by the same reference numerals, and detailed description of the components and operations will be omitted.

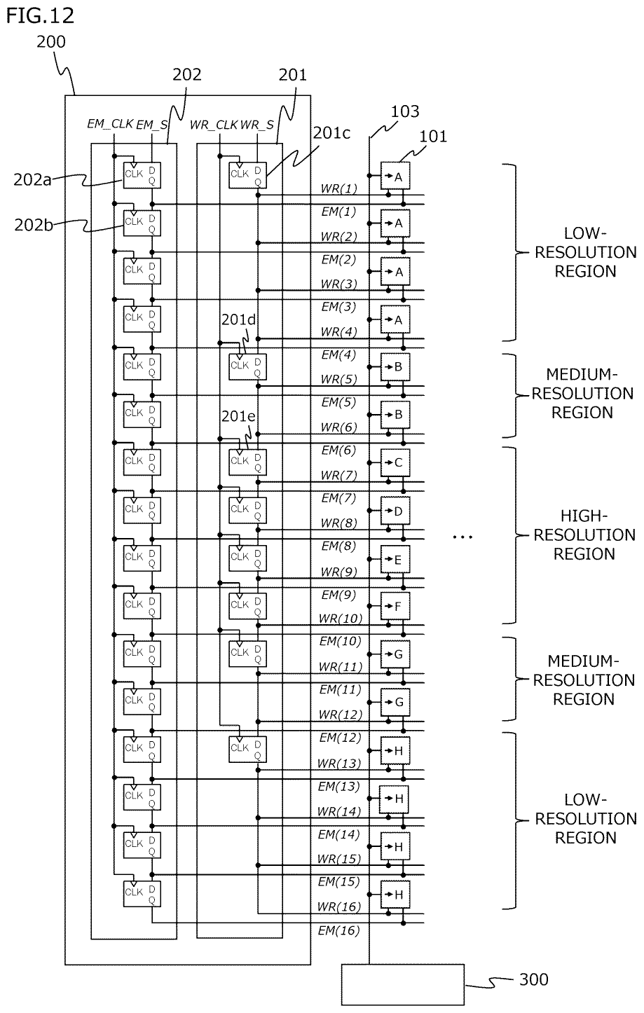

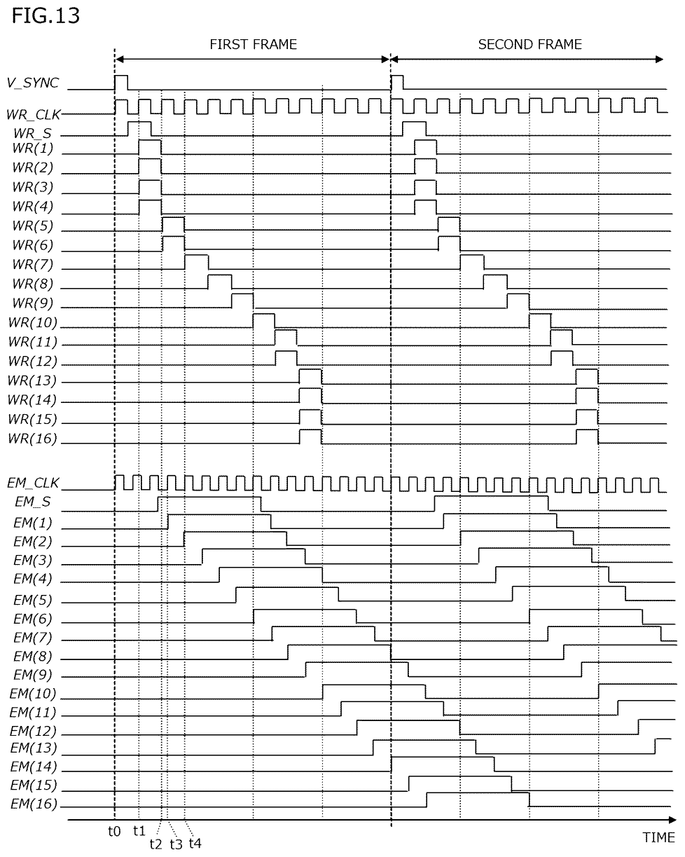

FIG. 12 is a diagram illustrating an example of the configuration of the vertical scanning circuit 200 of the display apparatus 1 according to this modification. In addition, FIG. 13 is a diagram illustrating an operation timing which is an example of the drive waveform of the vertical scanning circuit 200 according to this modification. In the vertical scanning circuit 200 illustrated in FIG. 12, the write scanning circuit 201 and the light emission scanning circuit 202 are different in configuration from the write scanning circuit 201 and the light emission scanning circuit 202 illustrated in FIG. 4.

Specifically, as illustrated in FIG. 12, for example, the pixel array 100 is divided into the low-resolution region, the medium-resolution region, the high-resolution region. In addition, in the write scanning circuit 201, for the low-resolution region, four write selection lines (selection lines for WR(1) to WR(4) transmission) are connected to one D-Flip Flop circuit 201c. In addition, for the medium-resolution region, two write selection lines (selection lines for WR(5) and WR(6) transmission) are connected to one D-Flip Flop circuit 201d. In addition, for the high-resolution region, one write selection line (selection line for WR(7) transmission) is connected to one D-Flip Flop circuit 201e. In each resolution region, other D-Flip Flop circuits are also configured similarly. Note that the number of write selection lines connected to the D-Flip Flop circuits in each resolution region is not limited thereto. In this way, the number of write selection lines connected to one D-Flip Flop circuit differs for each of a plurality of regions where image data with different resolutions are displayed.

Accordingly, as shown in the operation timing chart of FIG. 13, the display apparatus 1 of this modification performs light emission of the unit pixel drive circuit 101 in units of one row in any resolution region. In addition, the display apparatus 1 sequentially emits light at a constant scanning speed over the entire pixel array 100.

An operation of the display apparatus 1 according to this modification will be described. As shown in the operation timing chart of FIG. 13, V_SYNC becomes the H level at time t0 to start one frame. Here, the write scanning circuit 201 writes signal voltages to four unit pixel drive circuits 101 connected to the same image signal line 103 in the low-resolution region. For example, when WR_CLK becomes the H level at time t1, the D-Flip Flop circuit 201c of the first stage of the write scanning circuit 201 latches the H level of the WR_S, which is an input. Then, the D-Flip Flop circuit 201c outputs the H level to the write selection lines for WR(1), WR(2), WR(3), and WR(4) transmission. Accordingly, the image signal A output from the signal output circuit 300 to the image signal line 103 at time t1 is written in the unit pixel drive circuits 101 arranged in four rows.

In addition, in the medium-resolution region, the write scanning circuit 201 writes signal voltages to two unit pixel drive circuits 101. For example, when WR CLK becomes the H level at time t2, a D-Flip Flop circuit 201d of a second stage of the write scanning circuit 201 latches the H level of the write selection lines for WR (1), WR(2), WR(3), and WR(4) transmission, which are inputs. Then, the D-Flip lop circuit 201d outputs the H level to the write selection lines for WR(5) and WR(6) transmission. Accordingly, an image signal B output from the signal output circuit 300 to the image signal line 103 at time t2 is written in the unit pixel drive circuits 101 arranged in two rows.

In addition, in the high-resolution region, the write scanning circuit 201 writes a signal voltage to one unit pixel drive circuit 101. For example, when WR_CLK becomes the H level at time t4, the D-Flip Flop circuit 201e at a third stage of the write scanning circuit 201 latches the H level of the write selection lines for WR(5) and WR(6) transmission, which are inputs, and outputs the H level to the write selection lines for WR(7) transmission.

By scanning in this way, data is sequentially written to the pixel drive circuits in the low-resolution region, the medium-resolution region, and the high-resolution region. Accordingly, the display apparatus 1 can reduce the latency related to image display in a manner similar to that of the circuit configuration illustrated in FIG. 4.

In addition, as for scanning by the light emission scanning circuit 202, for example, when the EM_CLK becomes the H level at time t3, the D-Flip Flop circuit 202a of the first stage of the light emission scanning circuit 202 latches the H level of the EM_S, which is an input. Then, the D-Flip Flop circuit 202a outputs the H level to the light emission selection line for EM(1) transmission. In addition, when the EM CLK becomes the H level again at time t4, the D-Flip Flop circuit 202b at the second stage of the light emission scanning circuit 202 latches the H level of the light emission selection line for EM(1) transmission, which is an input, and outputs the H level to the light emission selection line for EM(2) transmission. When the light emission scanning circuit 202 performs scanning in this way, in the light emission period of the pixel array 100, light emission of the light emitting elements is sequentially performed at a constant scanning speed regardless of the low-resolution region, the medium-resolution region, and the high-resolution region. Accordingly, in the display apparatus 1, the light emission area in the pixel array 100 can be made uniform.

### Sixth Modification

Next, a sixth modification of the above-described embodiment will be described. Note that in the following description, components similar to those of the display apparatus 1 according to the above-described embodiment are denoted by the same reference numerals, and detailed description of the components and operations will be omitted.

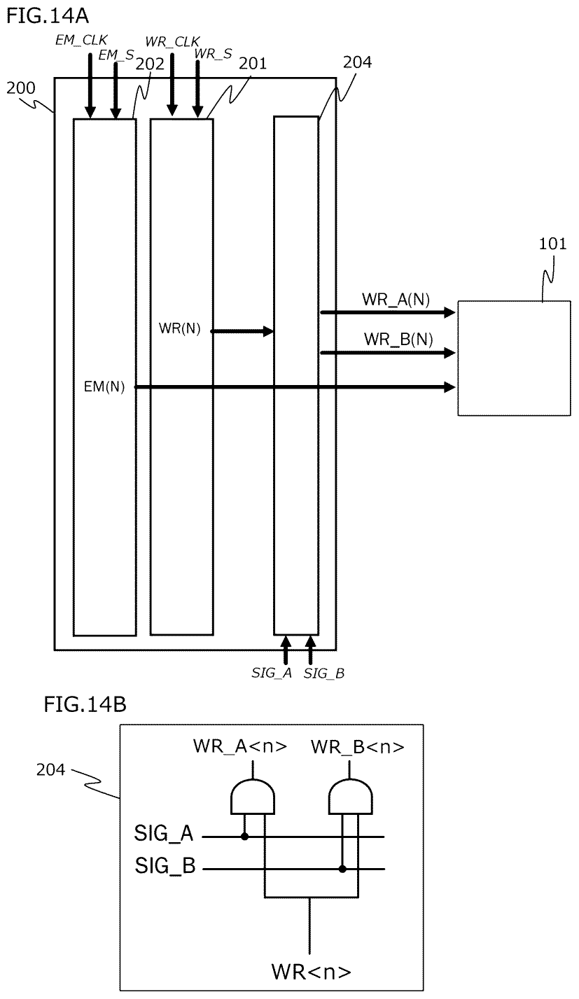

The operation of the vertical scanning circuit 200 of the above-described embodiment is an example, the light emission control signal EM(N) and the write control signal WR(N) in FIG. 4 may be logically operated with other control signals by using an arbitrary logic gate circuit, and the resulting outcome may be output as control signals to the unit pixel drive circuit 101. FIG. 14A illustrates an example of the configuration of the vertical scanning circuit 200 according to this modification. In this modification, for example, the vertical scanning circuit 200 includes the write scanning circuit 201, the light emission scanning circuit 202, and the output control logic gate circuit 204 connected to the unit pixel drive circuit 101.

In addition, FIG. 14B illustrates an example of the configuration of the output control logic gate circuit 204. The output control logic gate circuit 204 outputs, as write control signal WR_A(N) and the control signal WR_B(N), a logical product between control signals SIG_A and SIG_B to be input to the unit pixel drive circuit 101 and the write control signal WR(N). In this way, the output control logic gate circuit 204 is connected to the outputs of the write scanning circuit 201 and the light emission scanning circuit 202, and the result of the logic operation is output to the unit pixel drive circuit 101.

In addition, the write control signal and the light emission control signal may not be one type. In addition, by adding circuits such as switches, D-Flip Flop, and a decoder to the write scanning circuit 201, the positions of, for example, the low-resolution region and the high-resolution region in the pixel array 100 may be changed dynamically. In addition, in each row, when writing and light emission are performed, it is not necessary to fix the write control signal and the light emission control signal at the H level, and there may be a period of L level. In addition, each of the above-described circuits do not need to operate in positive logic, and some or all of the circuits may be configured to operate in negative logic.

### Second Embodiment

A display apparatus according to a second embodiment of the present invention will be described below. Note that in the following description, components similar to those of the display apparatus 1 according to the first embodiment are denoted by the same reference numerals, and detailed description of the components and operations is omitted.

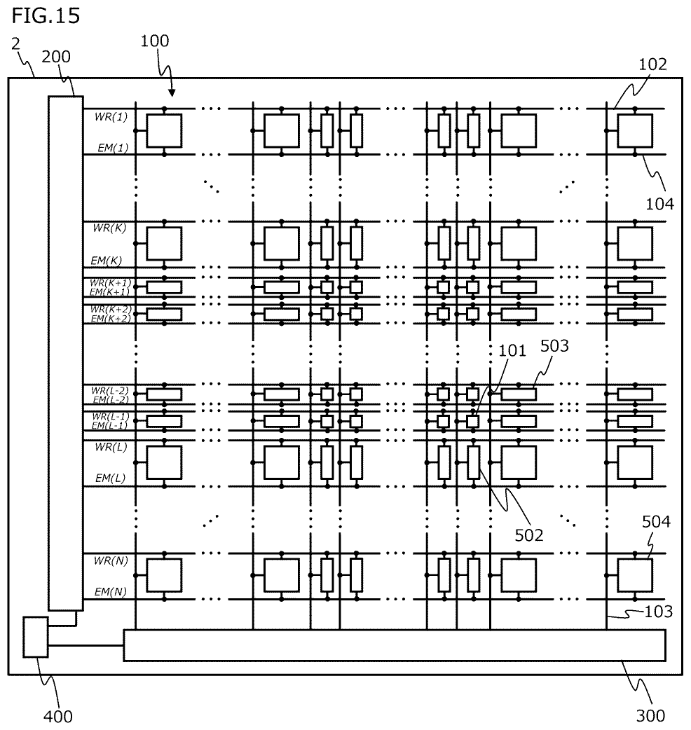

FIG. 15 is a schematic diagram illustrating an example of a configuration of a display apparatus 2 according to the present embodiment. The display apparatus 2 includes the pixel array 100, the vertical scanning circuit 200, the signal output circuit 300, and the control circuit 400. In the present embodiment, the pixel array 100 of the display apparatus 2 includes, in addition to the unit pixel drive circuit 101, pixel drive circuits 502 and 503 each having a light emission area twice that of the unit pixel drive circuit 101, and a pixel drive circuit 504 having a light emission area four times that of the unit pixel drive circuit 101. Note that in FIG. 15, other pixel drive circuits having the same shape as each of the pixel drive circuits 101, 502, 503, and 504 are also configured similarly to the corresponding pixel drive circuits 101, 502, 503, and 504.

In the display apparatus 2, for example, as compared with the unit pixel drive circuit 101 in FIG. 2, a channel width of the drive transistor 113 and an area of the light emitting diode 114 are twice as large for the pixel drive circuits 502 and 503, and four times as large for the pixel drive circuit 504. Accordingly, the light emission area by the pixel drive circuits 502 and 503 can be twice or four times as large. In addition, the pixel drive circuit 502 has twice the area in the vertical direction compared to the unit pixel drive circuit 101, and the pixel drive circuit 503 has twice the area in the horizontal direction compared to the unit pixel drive circuit 101. In addition, the pixel drive circuit 504 has twice the area in both the vertical and horizontal directions compared to the unit pixel drive circuit 101. In the present embodiment, the region formed by the pixel drive circuit 504 corresponds to the low-resolution region. In addition, the regions formed by the pixel drive circuits 502 and 503 correspond to the medium-resolution region. In addition, the region formed by the unit pixel drive circuit 101 corresponds to the high-resolution region. In this way, in the display apparatus 2 according to the present embodiment, sizes of the pixel drive circuits differ for each region with a specific resolution in the pixel array.

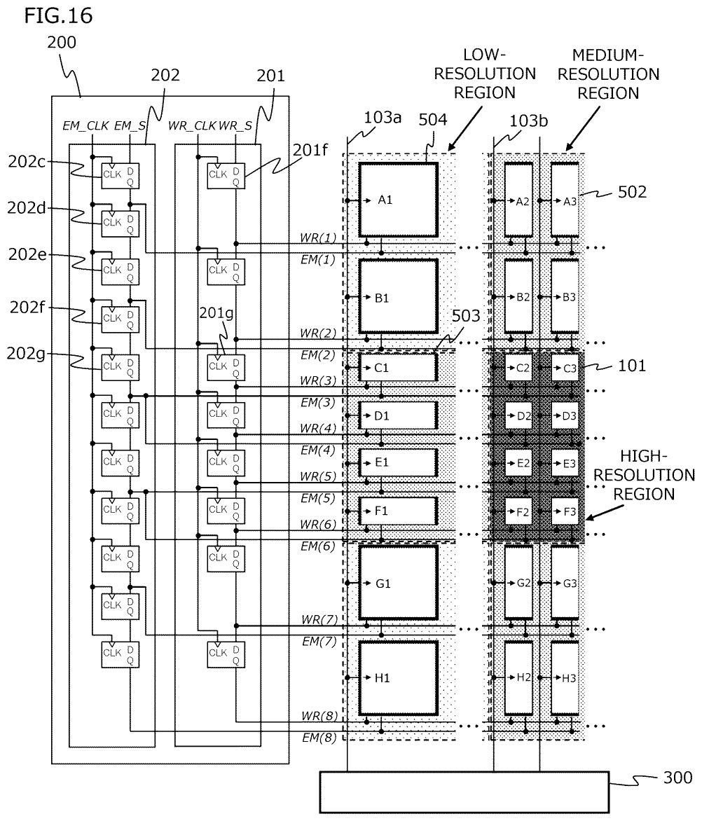

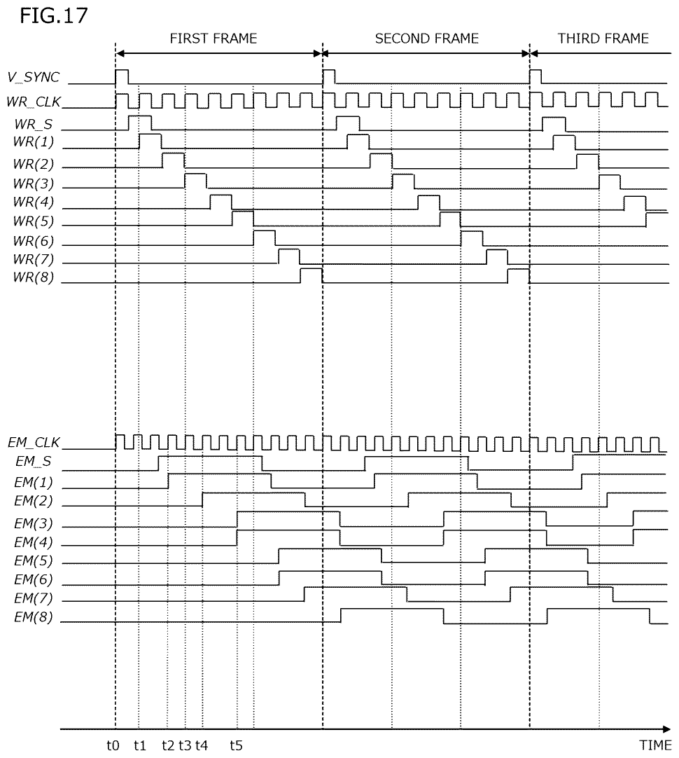

FIG. 16 illustrates an example of the configuration of the vertical scanning circuit 200 in the present embodiment, and FIG. 17 illustrates an operation timing chart which is an example of the drive waveform of the vertical scanning circuit 200 in the present embodiment. As illustrated in FIG. 16, the vertical scanning circuit 200 is constituted by the write scanning circuit 201 and the light emission scanning circuit 202, and the write scanning circuit 201 and the light emission scanning circuit 202 are shift register circuits in which D-Flip Flop circuits are cascade-connected in the column direction of the pixel array. The write start pulse WR_S and the write clock WR_CLK are supplied to the write scanning circuit 201, and the light emission start pulse EM_S and the write clock EM_CLK are supplied to the light emission scanning circuit 202.

In the configuration illustrated in FIG. 16, two kinds of image signal lines are provided, that is, an image signal line 103a to which the pixel drive circuit 503 and the pixel drive circuit 504 are connected, and an image signal line 103b to which the unit pixel drive circuit 101 and the pixel drive circuit 502 are connected. However, a scanning method described below is performed similarly for any image signal line.

As illustrated in FIG. 17, V_SYNC becomes the H level at time t0 to start one frame. Here, the write scanning circuit 201 writes signal voltages to the pixel drive circuits 504 in the low-resolution region and the pixel drive circuit 502 in the medium-resolution region. For example, when the WR_CLK becomes the H level at time t1, a D-Flip Flop circuit 201f at the first stage of the write scanning circuit 201 latches the H level of the WR_S, which is an input, and outputs the H level to the write selection line for WR(1) transmission. Accordingly, an image signal A1 output from the signal output circuit 300 to the image signal line 103a at time t1 is written to the pixel drive circuit 504, and an image signal A2 and an image signal A3 output to the image signal line 103b are written to the pixel drive circuit 502. In addition, the write scanning circuit 201 writes signal voltages to the pixel drive circuits 503 in the medium-resolution region and the unit pixel drive circuit 101 in the high-resolution region. For example, when the WR_CLK becomes the H level at time t3, a D-Flip Flop circuit 201g at the third stage of the write scanning circuit 201 latches the H level of the write selection line for WR(2) transmission, which is an input, and outputs the H level to the write selection line for WR(3) transmission. Accordingly, an image signal Cl output to the image signal line 103a from the signal output circuit 300 at time t3 is written to the pixel drive circuit 503, and an image signal C2 and an image signal C3 output to the image signal line 103b are written to the unit pixel drive circuit 101. By scanning in this way, data is sequentially written to the pixel drive circuit 503 in the low-resolution region, the pixel drive circuits 502 and 504 in the medium-resolution region, and the unit pixel drive circuit 101 in the high-resolution region.

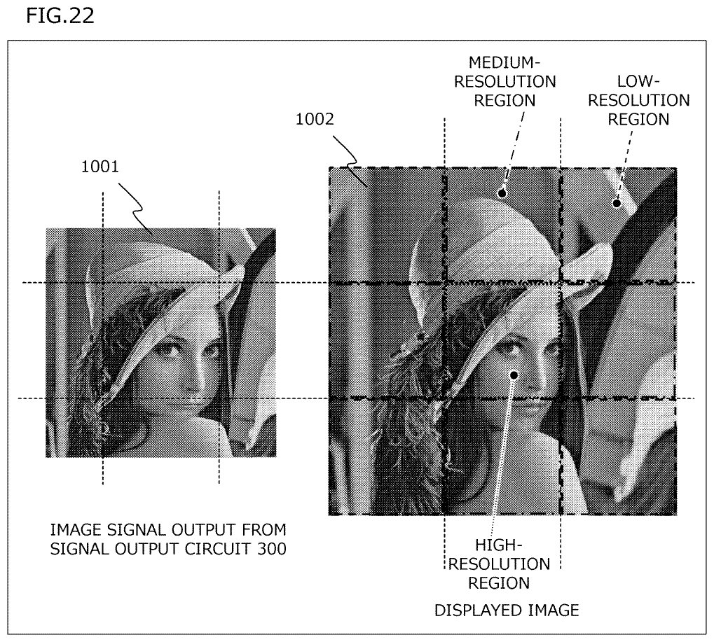

FIG. 22 illustrates an example of a relationship between an image signal 1001 output from the signal output circuit 300 and a display image 1002 displayed on the pixel array 100 in the signal voltage writing by the display apparatus 2. According to the signal voltage writing of the display apparatus 2 described above, in order to display the display image 1002 illustrated in FIG. 22, the image signal 1001 output from the signal output circuit 300 has a reduced amount of image data in the low-resolution region and the medium-resolution region in the row direction. Accordingly, the display apparatus 2 can reduce a latency related to image display by sending an externally transmitted image signal from the signal output circuit 300 to the pixel array 100 as it is without expanding the image signal in the control circuit 400 and the signal output circuit 300.

As for the scanning by the light emission scanning circuit 202 shown in the operation timing chart of FIG. 17, for example, when the EM_CLK becomes the H level at time t2, a D-Flip Flop circuit 202c at the first stage of the light emission scanning circuit 202 latches the H level of the EM_S, which is an input. Then, the D-Flip Flop circuit 202c outputs the H level to the light emission selection line for EM(1) transmission. In addition, when the EM_CLK becomes the H level again at time t4, a D-Flip Flop circuit 202e at the third stage of the light emission scanning circuit 202 latches the H level of a D-Flip Flop circuit 202d at the second stage, which is an input, and outputs the H level to the light emission selection line for EM(2) transmission. When the EM_CLK becomes the H level again at time t5, a D-Flip Flop circuit 202g at a fifth stage of the light emission scanning circuit 202 latches the H level of a D-Flip Flop circuit 202f at a fourth stage of the light emission scanning circuit 202, which is the input. Then, the D-Flip Flop circuit 202g outputs the H level to the light selection line for EM(3) transmission and the light selection line for EM(4) transmission. When the light emission scanning circuit 202 performs scanning this way, in the display apparatus 2, in the light emission period of the pixel array 100, light emission of the light emitting elements is sequentially performed at a constant scanning speed regardless of the low-resolution region, the medium-resolution region, and the high-resolution region.

Accordingly, in the display apparatus 2 according to the present embodiment, in the column direction of the pixel array 100 (the scanning direction of the vertical scanning circuit 200), a length of a light emitting region in the high-resolution region during the light emission is equal to a length of a light emitting region in the pixel drive circuit 502 in the medium-resolution region and the pixel drive circuit 504 in the low-resolution region during the light emission. Accordingly, even in a case where a pixel area is different between regions of different resolutions in the display apparatus 2, the light emission area in the pixel array 100 can be made uniform regardless of the regions.

In addition, in the present embodiment, similarly to the first embodiment, the speed of scanning by the light emission scanning circuit 202 is at least the speed of scanning by the write scanning circuit 201 for the high-resolution region and less than the speed of scanning by the write scanning circuit 201 for the low-resolution region. That is, in the present embodiment, the speed of scanning by the write scanning circuit 201 is not uniform for each of a plurality of regions where image data with different resolutions in the pixel array 100 are displayed. In addition, the speed of scanning by the light emission scanning circuit 202 over the plurality of regions is at least the lowest speed of scanning by the write scanning circuit 201 and less than the highest speed thereof.

### Seventh Modification

Next, a seventh modification, which is a modification of the second embodiment, will be described. Note that in the following description, components similar to those of the display apparatus 2 according to the above-described embodiment are denoted by the same reference numerals, and detailed description of the components and operations will be omitted.

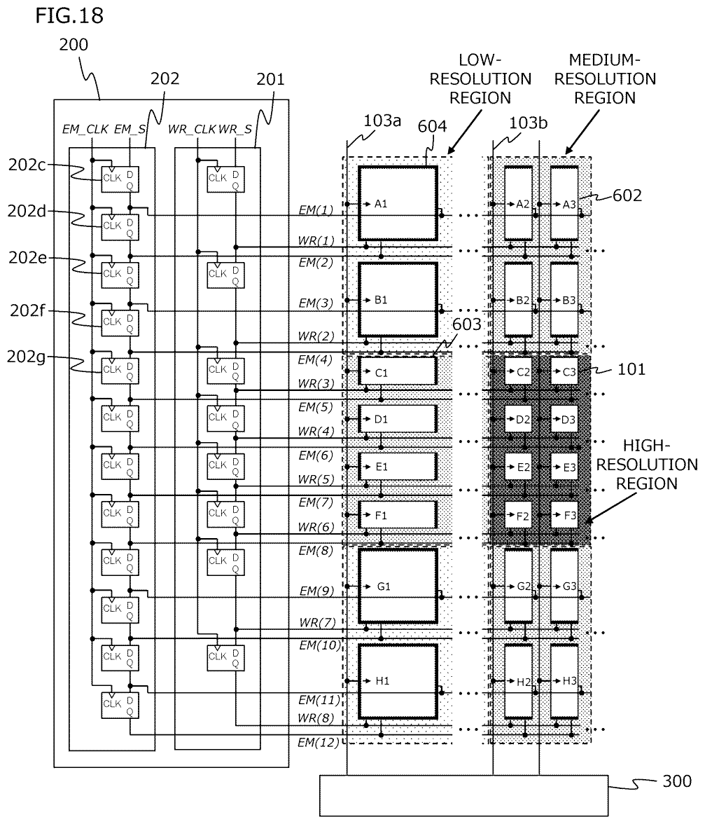

FIG. 18 illustrates an example of the configuration of the vertical scanning circuit 200 and the pixel array 100 according to this modification. As illustrated in FIG. 18, the vertical scanning circuit 200 is constituted by the write scanning circuit 201 and the light emission scanning circuit 202, and the write scanning circuit 201 and the light emission scanning circuit 202 are shift register circuits in which D-Flip Flop circuits are cascade-connected in the column direction of the pixel array. The write start pulse WR_S and the write clock WR_CLK are supplied to the write scanning circuit 201, and the light emission start pulse EM_S and the write clock EM_CLK are supplied to the light emission scanning circuit 202. Note that in FIG. 18, other pixel drive circuits having the same shape as each of pixel drive circuits 101, 602, 603, and 604 are also configured similarly to the corresponding pixel drive circuits 101, 602, 603, and 604.

In addition, in the configuration of FIG. 18, the pixel drive circuits 602, 603, and 604 are pixel drive circuits corresponding to the pixel drive circuits 502, 503, and 504 in the second embodiment. Note that details of the configuration of the pixel drive circuits 602, 603, and 604 will be described later. In addition, two kinds of image signal lines are provided, that is, the image signal line 103a to which the pixel drive circuit 603 and the pixel drive circuit 604 are connected, and the image signal line 103b to which the unit pixel drive circuit 101 and the pixel drive circuit 602 are connected. However, the scanning method described below is performed similarly for any image signal line.

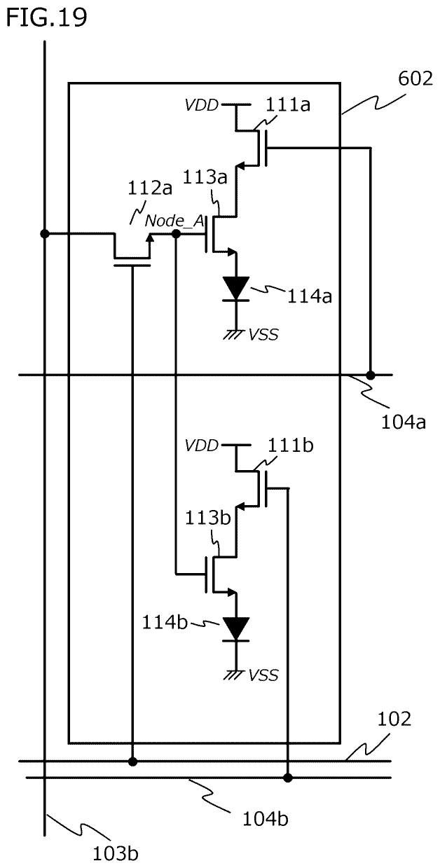

FIG. 19 illustrates an example of a configuration of the pixel drive circuit 602. The pixel drive circuit 602 includes one write control transistor 112a, two light emission control transistors 111a and 111b, two drive transistors 113a and 113b, and two light emitting diodes 114a and 114b. Cathode terminals of the light emitting diodes 114a and 114b are connected to the VSS, which is a ground level, and anode terminals of the light emitting diodes 114a and 114b are connected to source terminals of the drive transistors 113a and 113b, respectively. Drain terminals of the drive transistors 113a and 113b are connected to source terminals of the light emission control transistors 111a and 111b, respectively, and gate terminals of the drive transistors 113a and 113b are connected to the source terminal of the write control transistor 112. Drain terminals of the light emission control transistors 111a and 111b are connected to the VDD, which is a power source, and gate terminals of the light emission control transistors 111a and 111b are connected to light emission selection lines 104a and 104b, respectively. The drain terminal of the write control transistor 112 is connected to the image signal line 103b, and the gate terminal of the write control transistor 112 is connected to the write selection line 102.

Since the operation of the pixel drive circuit 602 is similar to that of FIG. 2, detailed description thereof will be omitted here. According to the pixel drive circuit 602 of FIG. 19, the two light emission selection lines 104a and 104b are provided, and thus the number of light emitting diodes to emit light can be controlled to (one or two) by causing only one of the light emitting diodes 114a and 114b or both to emit light.

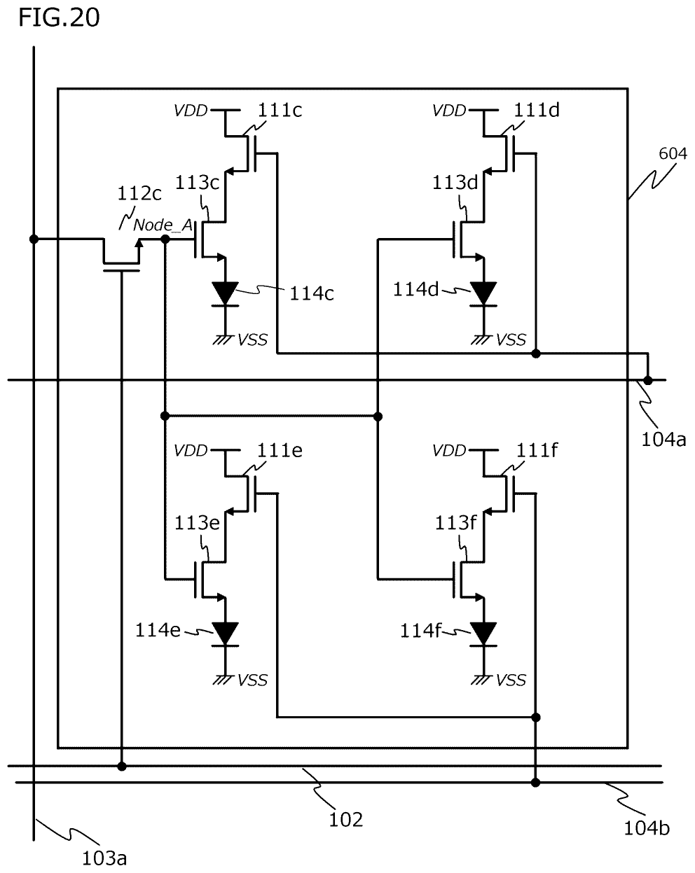

FIG. 20 illustrates an example of a configuration of the pixel drive circuit 604. The pixel drive circuit 604 includes one write control transistor 112c and four light emission control transistors 111c, 111d, 111e, and 111f. In addition, the pixel drive circuit 604 also includes four drive transistors 113c, 113d, 113e, and 113f and four light emitting diodes 114c, 114d, 114e, and 114f. Cathode terminals of the light emitting diodes 114c, 114d, 114e, and 114f are connected to the VSS, which is a ground level. Anode terminals of the light emitting diodes 114c, 114d, 114e, and 114f are connected to source terminals of the drive transistors 113c, 113d, 113e, and 113f, respectively. Drain terminals of the drive transistors 113c, 113d, 113e, and 113f are connected to source terminals of the light emission control transistors 111c, 111d, 111e, and 111f, respectively. Gate terminals of the drive transistors 113c, 113d, 113e, and 113f are connected to a source terminal of the write control transistor 112c. Drain terminals of the light emission control transistors 111c, 111d, 111e, and 111f are connected to the VDD which is a power source. Gate terminals of the light emission control transistors 111c and 111d are connected to the light emission selection line 104a, and gate terminals of the light emission control transistors 111e and 111f are connected to the light emission selection line 104b. A drain terminal of the write control transistor 112c is connected to the image signal line 103a, and a gate terminal of the write control transistor 112c is connected to the write selection line 102.

Since the operation of the pixel drive circuit 604 is similar to that of FIG. 2, detailed description thereof will be omitted here. According to the pixel drive circuit 604 of FIG. 20, the two light emission selection lines 104a and 104b are provided, and thus only one of a set of the light emitting diodes 114c and 114d and a set of the light emitting diodes 114e and 114f or both can be caused to emit light. Accordingly, the number of light emitting diodes to emit light can be controlled to (two or four) by the pixel drive circuit 604.

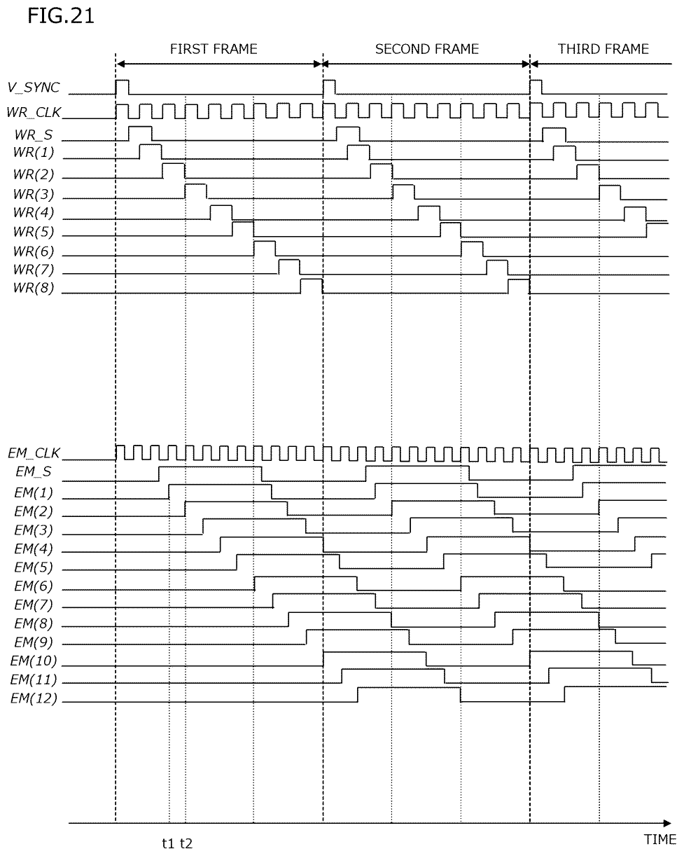

FIG. 21 is an operation timing chart which is an example of the drive waveform of the vertical scanning circuit 200 in the present embodiment. As for the scanning by the light emission scanning circuit 202 shown in the operation timing chart of FIG. 21, for example, when the EM_CLK becomes the H level at time t1, the D-Flip Flop circuit 202c of at the first stage of the light emission scanning circuit 202 latches the H level of the EM_S, which is an input. Then, the D-Flip Flop circuit 202c outputs the H level to the light emission selection line for EM(1) transmission. In addition, when the EM_CLK becomes the H level again at time t2, the D-Flip Flop circuit 202d at the second stage of the light emission scanning circuit 202 latches the H level of the light emission selection line for EM(1) transmission, which is an input, and outputs the H level to the light emission selection line for EM(2) transmission. When the light emission scanning circuit 202 performs scanning this way, in the display apparatus 2, in the light emission period of the pixel array 100, light emission of the light emitting elements is sequentially performed at a constant scanning speed regardless of the low-resolution region, the medium-resolution region, and the high-resolution region. Accordingly, in the display apparatus 2, the light emission area in the pixel array 100 can be made uniform.

Accordingly, in the display apparatus 2 according to this modification, the light emission scanning circuit 202 performs scanning such that an amount of light emission in the pixel drive circuit in a region of a relatively low resolution among a plurality of resolution regions is determined in accordance with a size of the pixel drive circuit in a region of a relatively high resolution. In addition, in this modification, in the column direction of the pixel array 100 (the scanning direction of the vertical scanning circuit 200), the light emitting regions of the pixel drive circuit 602 in the medium-resolution region and the pixel drive circuit 604 in the low-resolution region during the light emission have the same length as that of the light emitting region in the high-resolution region during the light emission. Accordingly, even in a case where a pixel area is different between regions of different resolutions in the display apparatus 2, the light emission area in the pixel array 100 can be made uniform regardless of the regions.

[Organic Light Emitting Element] Next, an example of an organic light emitting element that can be used in the display apparatus according to the first and second embodiments will be described.

In the display apparatus according to the first and second embodiments, the organic light emitting element has a first electrode, a second electrode, and an organic compound layer arranged between the electrodes. One of the first electrode and the second electrode is an anode and another is a cathode. In the first and second embodiments, as long as the organic compound layer has a light emitting layer, the organic compound layer may be a single layer or may be a laminate including a plurality of layers. Here, in a case where the organic compound layer is the laminate including a plurality of layers, the organic compound layer includes, in addition to the light emitting layer, a hole injection layer, a hole transport layer, an electron blocking layer, a hole-exciton blocking layer, an electron transport layer, an electron injection layer, and the like. In addition, the light emitting layer may be a single layer or a laminate including a plurality of layers. If the light emitting layer is a multi-layer, a charge generation layer may be provided between the light emitting layers. The charge generation layer may be composed of a compound having a lower LUMO than that of the hole transport layer, and the LUMO of the charge generation layer may be lower than a hole transport layer HOMO. Here, a molecular orbital energy of the organic compound layer may be a molecular orbital energy of an organic compound having a largest weight ratio of the organic compound layer.

In the first and second embodiments, in a case where the organic compound is included in the light emitting layer, the light emitting layer may be a layer including only the organic compound or may be a layer including an organometallic complex and another compound. Here, in a case where the light emitting layer is the layer including an organometallic complex and another compound, the organic compound may be used as a host for the light emitting layer or may be used as a guest. In addition, the organic compound may also be used as an assist material that may be included in the light emitting layer. Here, the host is a compound having a largest mass ratio among compounds constituting the light emitting layer. In addition, the guest is a compound, which has a smaller mass ratio than that of the host and is responsible for the main light emission, among the compounds constituting the light emitting layer. In addition, the assist material is a compound, which has a smaller mass ratio than that of the host and assists the light emission of the guest, among the compounds constituting the light emitting layer. Note that the assist material is also referred to as a second host. The host material may also be referred to as a first compound and the assist material may be referred to as a second compound.

Here, the organic compound may, as needed, be used together with conventionally known low-molecular and high-molecular hole-injecting compounds or hole-transporting compounds, host compounds, light-emitting compounds, electron-injecting compounds, electron-transporting compounds, or the like.

As the hole-injecting/transporting material, a material having high hole mobility is preferred so that the injection of holes from the anode is facilitated and the injected holes can be transported to the light emitting layer. Further, in the organic light emitting element, a material having a high glass transition temperature is preferred to reduce degradation in film quality such as crystallization.

The electron-transporting material may be arbitrarily selected from those capable of transporting electrons injected from the cathode to the light emitting layer, and may be selected in consideration of a balance with the hole mobility of the hole-transporting material, or the like. The electron-transporting material is also suitably used for a hole blocking layer.

The electron-injecting material may be arbitrarily selected from those that allow easy electron injection from the cathode, and is selected in consideration of a balance with hole injection properties. The electron-injecting material may also be used in combination with the electron transport material.

[Structure of an Organic Light-Emitting Element] An organic light-emitting element organic light-emitting element is provided by forming an insulating layer, a first electrode, an organic compound layer and a second electrode, on a substrate. A protective layer, a color filter, a microlens and so forth may be provided on a cathode. In a case where a color filter is provided, a planarization layer may be provided between the color filter and the protective layer. The planarization layer can be for instance made up of an acrylic resin. The same is true in a case where the planarization layer is provided between the color filter and the microlens.

[Substrate] At least one material selected from quartz, glass, silicon, resins and metals can be used as the material for the substrate that makes up the organic light-emitting element. Switching elements such as transistors and wiring may be provided on the substrate, and an insulating layer may be provided on the foregoing.

Any material can be used as the insulating layer so long as a contact hole can be formed between the insulating layer and the first electrode, and insulation from unconnected wiring can be ensured, so that wiring can be formed between the first electrode and the insulating layer. For instance a resin such as a polyimide, or silicon oxide or silicon nitride can be used herein.

[Electrodes] A pair of electrodes can be used as the electrodes of the organic light-emitting element. The pair of electrodes may be an anode and a cathode. In a case where an electric field is applied in the direction in which the organic light-emitting element emits light, the electrode of higher potential is the anode, and the other electrode is the cathode. Stated otherwise, the electrode that supplies holes to the light-emitting layer is the anode, and the electrode that supplies electrons is the cathode.

A material having a work function as large as possible is preferable herein as a constituent material of the anode. For instance single metals such as gold, platinum, silver, copper, nickel, palladium, cobalt, selenium, vanadium or tungsten, and mixtures containing the foregoing metals, can be used in the anode. Alternatively, alloys obtained by combining these single metals, or metal oxides such as tin oxide, zinc oxide, indium oxide, indium tin oxide (ITO) or indium zinc oxide, may be used in the anode. Conductive polymers such as polyaniline, polypyrrole and polythiophene can also be used in the anode.

Any of the foregoing electrode materials may be used singly; alternatively, two or more materials may be used concomitantly. The anode may be made up of a single layer, or may be made up of a plurality of layers.

In a case where an electrode of the organic light-emitting element is configured in the form of a reflective electrode, the electrode material can be for instance chromium, aluminum, silver, titanium, tungsten, molybdenum, or alloys or layered bodies of the foregoing. The above materials can also function as a reflective film not having a role as an electrode. In a case where an electrode of the organic light-emitting element is configured in the form of a transparent electrode, for instance an oxide transparent conductive layer of for instance indium tin oxide (ITO) or indium zinc oxide can be used, although not particularly limited thereto, as the electrode material. The electrodes may be formed by photolithography.

A material having a small work function may be a constituent material of the cathode. For instance alkali metals such as lithium, alkaline earth metals such as calcium, single metals such as aluminum, titanium, manganese, silver, lead or chromium, and mixtures of the foregoing, may be used herein. Alternatively, alloys obtained by combining these single metals can also be used. For instance magnesium-silver, aluminum-lithium, aluminum-magnesium, silver-copper or zinc-silver can be used. Metal oxides such as indium tin oxide (ITO) can also be used.

These electrode materials may be used singly as one type, or two or more types can be used concomitantly. Also, the cathode may have a single-layer structure or a multilayer structure. Silver is preferably used among the foregoing, and more preferably a silver alloy, in order to reduce silver aggregation. Any alloy ratio can be adopted, so long as silver aggregation can be reduced. A ratio silver: other metal may be for instance 1:1, or 3:1.

Although not particularly limited thereto, the cathode may be a top emission element that utilizes an oxide conductive layer of ITO or the like, or may be a bottom emission element that utilizes a reflective electrode of aluminum (Al) or the like. The method for forming the cathode is not particularly limited, but more preferably for instance a DC or AC sputtering method is resorted to, since in that case film coverage is good and resistance can be readily lowered.

[Pixel Separation Layer] The pixel separation layer of the organic light-emitting element is formed out of a silicon nitride (SiN) film, a silicon oxynitride (SiON) film, or a silicon oxide (SiO) film, in turn having been formed by chemical vapor deposition (CVD). In order to increase the in-plane resistance of the organic compound layer, preferably the thickness of the organic compound layer that is formed, particularly a hole transport layer, is set to be small at the side walls of the pixel separation layer. Specifically, the side walls can be formed to be thin by increasing vignetting at the time of deposition, through an increase of the taper angle of the side walls of the pixel separation layer and/or an increase of the thickness of the pixel separation layer.

On the other hand, it is preferable to adjust the side wall taper angle of the pixel separation layer and the thickness of the pixel separation layer so that no voids are formed in the protective layer that is formed on the pixel separation layer. The occurrence of defects in the protective layer can be reduced by virtue of the fact that no voids are formed in the protective layer. Since the occurrence of defects in the protective layer is thus reduced, it becomes possible to reduce loss of reliability for instance in terms of the occurrence of dark spots or defective conduction in the second electrode.

The present embodiment allows effectively suppressing leakage of charge to adjacent pixels even when the taper angle of the side walls of the pixel separation layer is not sharp. Studies by the inventors of the present application have revealed that leakage of charge to adjacent pixels can be sufficiently reduced if the taper angle lies in the range at least 60 degrees and not more than 90 degrees. The thickness of the pixel separation layer is preferably at least 10 nm and not more than 150 nm. A similar effect can be achieved also in a configuration having only a pixel electrode lacking a pixel separation layer. In this case, however, it is preferable to set the film thickness of the pixel electrode to be half or less the thickness the organic layer, or to impart forward taper at the ends of the pixel electrode, at a taper angle smaller than 60 degrees, since short circuits of the organic light-emitting element can be reduced thereby.

[Organic Compound Layer (Functional Layer)] The organic compound layer of the organic light-emitting element may be formed out of a single layer or multiple layers. In a case where the organic compound layer has multiple layers, these may be referred to as a hole injection layer, a hole transport layer, an electron blocking layer, a light-emitting layer, a hole blocking layer, an electron transport layer or an electron injection layer, depending on the function of the layer. The organic compound layer is mainly made up of organic compounds, but may contain inorganic atoms and inorganic compounds. For instance the organic compound layer may have copper, lithium, magnesium, aluminum, iridium, platinum, molybdenum or zinc. The organic compound layer may be disposed between the first electrode and the second electrode, and may be disposed in contact with the first electrode and the second electrode.

In the case of multiple light-emitting layers, the first and second light-emitting layers may have a charge generating portion between the first and second light-emitting layers. The charge generating portion may have an organic compound with a lowest unoccupied molecular orbital energy (LUMO) of −5.0 eV or less. The same is true in the case of providing a charge generating section between the second and third light-emitting layers.

[Protective Layer] In the organic light-emitting element of the present embodiment, a protective layer may be provided on the second electrode. For instance, intrusion of water or the like into the organic compound layer can be reduced, and the occurrence of display defects also reduced, by bonding a glass provided with a moisture absorbent onto the second electrode. As another embodiment, a passivation film of for instance silicon nitride may be provided on the cathode, to reduce intrusion of water or the like into the organic compound layer. For instance, formation of the cathode may be followed by conveyance to another chamber, without breaking vacuum, whereupon a protective layer may be formed through formation of a silicon nitride film having a thickness of 2 μm by CVD. The protective layer may be provided by atomic deposition (ALD), after film formation by CVD. The material of the film formed by ALD is not limited, but may be for instance silicon nitride, silicon oxide or aluminum oxide. Silicon nitride may be further formed, by CVD, on the film having been formed by ALD. The film formed by ALD may be thinner than the film formed by CVD. Specifically, the thickness of the film formed by ALD may be 50% or less, or 10% or less.

[Color Filter] A color filter may be provided on the protective layer of the organic light-emitting element of the present embodiment. For instance a color filter having factored therein the size of the organic light-emitting element may be provided on another substrate, followed by affixing to a substrate having the organic light-emitting element provided thereon; alternatively, a color filter may be patterned by photolithography on the protective layer illustrated above. The color filter may be made up of a polymer.

[Planarization Layer] The organic light-emitting element of the present embodiment may have a planarization layer between the color filter and the protective layer. The planarization layer is provided for the purpose of reducing underlying layer unevenness. The planarization layer may be referred to as a resin layer in a case where the purpose of the planarization layer is not limited. The planarization layer may be made up of an organic compound, which may be a low-molecular or high-molecular compound, preferably a high-molecular compound.

The planarization layer may be provided above and below the color filter, and the constituent materials of the respective planarization layers may be identical or dissimilar. Concrete examples include polyvinylcarbazole resins, polycarbonate resins, polyester resins, ABS resins, acrylic resins, polyimide resins, phenolic resins, epoxy resins, silicone resins and urea resins.

[Microlens] The display apparatus may have an optical member such as a microlens, on the light exit side. The microlens may be made up of for instance an acrylic resin or an epoxy resin. The purpose of the microlens may be to increase the amount of light extracted from the display apparatus, and to control the direction of the extracted light. The microlens may have a hemispherical shape. In a case where the microlens has a hemispherical shape, then from among tangent lines that are in contact with the hemisphere there is a tangent line that is parallel to the insulating layer, such that the point of contact between that tangent line and the hemisphere is the apex of the microlens. The apex of the microlens can be established similarly in any cross section. That is, among tangent lines that are in contact with a semicircle of the microlens in a sectional view, there is a tangent line that is parallel to the insulating layer, such that the point of contact between that tangent line and the semicircle is the apex of the microlens.

A midpoint of the microlens can also be defined. Given a hypothetical line segment from the end point of an arc shape to the end point of another arc shape, in a cross section of the microlens, the midpoint of that line segment can be referred to as the midpoint of the microlens. The cross section for discriminating the apex and the midpoint may be a cross section that is perpendicular to the insulating layer.

The microlens has a first surface with a bulge and a second surface on the reverse side from that of the first surface. Preferably, the second surface is disposed closer to a functional layer than the first surface. In adopting such a configuration, the microlens must be formed on the display apparatus. In a case where the functional layer is an organic layer, it is preferable to avoid high-temperature processes in the manufacturing process. If a configuration is adopted in which the second surface is disposed closer to the functional layer than the first surface, the glass transition temperatures of all the organic compounds that make up the organic layer are preferably 100° C. or higher, and more preferably 130° C. or higher.

[Counter Substrate] The organic light-emitting element of the present embodiment may have a counter substrate on the planarization layer. The counter substrate is so called because it is provided at a position corresponding to the above-described substrate. The constituent material of the counter substrate may be the same as that of the substrate described above. The counter substrate can be used as the second substrate in a case where the substrate described above is used as the first substrate.

[Organic Layer] Each organic compound layer (hole injection layer, hole transport layer, electron blocking layer, light-emitting layer, hole blocking layer, electron transport layer, electron injection layer and so forth) that makes up the organic light-emitting element of the present embodiment is formed in accordance with one of the methods illustrated below.

A dry process such as vacuum deposition, ionization deposition, sputtering, plasma or the like can be used for the organic compound layers that make up the organic light-emitting element of the present embodiment. A wet process in which a layer is formed through dissolution in an appropriate solvent, relying on a known coating method (for instance spin coating, dipping, casting, LB film deposition to inkjet.) can resorted to instead of a dry process.

When a layer is formed for instance by vacuum deposition or by solution coating, crystallization or the like is unlikelier occur; this translates into superior stability over time. In a case where a film is formed in accordance with a coating method, the film can be formed by being combined with an appropriate binder resin.

Examples of binder resins include, although not limited to, polyvinylcarbazole resins, polycarbonate resins, polyester resins, ABS resins, acrylic resins, polyimide resins, phenolic resins, epoxy resins, silicone resins and urea resins.

These binder resins may be used singly as one type, in the form of homopolymers or copolymers; alternatively, two or more types of binder resin may be used in the form of mixtures. Additives such as known plasticizers, antioxidants and ultraviolet absorbers may be further used concomitantly, as needed.

[Pixel Driving Circuit] A display apparatus having the organic light-emitting element of the present embodiment may have pixel driving circuits connected to respective organic light-emitting elements. The pixel driving circuits may be of active matrix type, and may control independently emission of light by the first organic light-emitting element and the second organic light-emitting element. Active matrix circuits may be voltage-programmed or current-programmed. A display apparatus has a pixel circuit for each pixel. Each pixel circuit may have an organic light-emitting element, a transistor that controls the emission luminance of the organic light-emitting element, a transistor that controls emission timing, a capacitor which holds the gate voltage of the transistor that controls emission luminance, and a transistor for connection to GND bypassing the light-emitting element.

The display apparatus has a display area and a peripheral area disposed around the display area. The display area has pixel driving circuits, and the peripheral area has a display control circuit. The mobility of the transistors that make up the pixel driving circuits may be lower than the mobility of the transistors that make up the display control circuit.

The slope of the current-voltage characteristic of the transistors that make up the pixel driving circuits may be gentler than the slope of the current-voltage characteristic of the transistors that make up the display control circuit. The slope of the current-voltage characteristics can be measured on the basis of a so-called Vg-Ig characteristic.

The transistors that make up the pixel driving circuits are connected to light-emitting elements such as the first organic light-emitting element.

[Pixels] The display apparatus of the present embodiment has a plurality of pixels. The pixels have sub-pixels that emit mutually different colors. The sub-pixels may have for instance respective RGB emission colors.

The pixels emit light in a pixel opening region. This region is the same as the first region. The aperture diameter of the pixel openings may be 15 μm or smaller, and may be 5 μm or larger. More specifically, the aperture diameter of the pixel openings may be for instance 11 μm, or 9.5 μm, or 7.4 μm, or 6.4 μm. The spacing between sub-pixels may be 10 μm or smaller, specifically 8 μm, or 7.4 μm, or 6.4 μm.

The pixels can have any known arrangement in a plan view. For instance, the pixel layout may be a stripe arrangement, a delta arrangement, a penile arrangement or a Bayer arrangement. The shape of the sub-pixels in a plan view may be any known shape. For instance, the sub-pixel shape may be for instance quadrangular, such as rectangular or rhomboidal, or may be hexagonal. Needless to say, the shape of the sub-pixels is not an exact shape, and a shape close to that a of rectangle falls under a rectangular shape. Sub-pixel shapes and pixel arrays can be combined with each other.

### Use of the Display Apparatus According to the First and Second Embodiments

The display apparatus according to the first and second embodiments can be used as a constituent member of a variety of equipment and apparatuses. Other uses of the display apparatus include light-emitting apparatuses having color filters, in white light sources.

The display apparatus may be an image information processing apparatus having an image input unit for input of image information, for instance from an area CCD, a linear CCD or a memory card, and an information processing unit for processing inputted information, such that an inputted image is displayed on a display unit. The display unit may include the display apparatus according to any one of the first to third embodiments.

A display unit of an imaging apparatus or of an inkjet printer may have the display apparatus according to any one of the first and second embodiments. The display unit may have a touch panel function. The driving scheme of this touch panel function may be an infrared scheme, a capacitive scheme, a resistive film scheme or an electromagnetic induction scheme, and is not particularly limited. The display apparatus may also be used in a display unit of a multi-function printer.

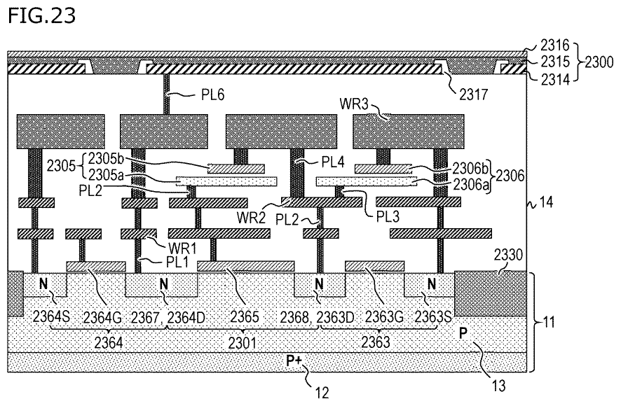

Next, a cross-sectional example of a part of the display apparatus of the first and second embodiments will be described with reference to FIG. 23. Note that for convenience of description, the elements and the like described above may be denoted by different reference numerals.

The display apparatus includes a substrate 11, an insulating layer 14, and a light emitting element 2300. The insulating layer 14 is located on the substrate 11. The light emitting element 2300 is located on the insulating layer 14. In other words, the insulating layer 14 is located between the substrate 11 and the light emitting element 2300.

The substrate 11 has a main surface (upper surface in FIG. 23) on which a drive transistor 2301, a write control transistor 2303, and a light emission control transistor 2302 are formed. The substrate 11 may be formed of, for example, a P-type semiconductor. A P-type well region 13 is formed on the main surface side of the substrate 11 (that is, on the upper side of the substrate 11). A region of the substrate 11 except for the well region 13 becomes a P-type semiconductor region 12.

The substrate 11 has, in the well region 13, a plurality of impurity regions that function as a source region or a drain region of the transistor. The impurity regions may be of N-type conductivity, for example.

A conductive layer 2365, a conductive layer 2363G, and a conductive layer 2364G are disposed on the main surface (upper surface) of the substrate 11. The conductive layer 2363G functions as a gate of the light emission control transistor 2363. One of the N-type impurity regions functions as a source 2363S of the light emission control transistor 2363, and another one of the N-type impurity regions functions as a drain 2363D. The conductive layer 2365 functions as a gate of a drive transistor 2361. The impurity region that functions as the drain 2363D of the light emission control transistor 2363 also functions as a source 2368 of the drive transistor 2301. In addition, one of other N-type impurity regions functions as a drain 2367 of the drive transistor 2301.

Furthermore, the conductive layer 2364G functions as a gate of a reset transistor 2364. In addition, the impurity region that functions as the source 2368 of the drive transistor 2301 also functions as a drain 2364D of the reset transistor 2364. In addition, one of other N-type impurity regions functions as a source 2364S of the reset transistor 2364.

The substrate 11 further includes an element isolation portion 2330 formed between adjacent pixels. As the element isolation portion 2330, shallow trench isolation (STI), local oxidation of silicon (LOCOS) isolation, P-type diffusion layer isolation, and the like may be used.

The light emitting element has a cathode 2316, an organic light emitting layer 2315, and an anode 2314. The cathode 2316 is electrically connected to a power supply line 2308. The anode 2314 is electrically connected to a main terminal (here, the drain) of the drive transistor 2301. The organic light emitting layer 2315 is located between the cathode 2316 and the anode 2314. A bank portion 2317 is disposed at an end of the anode 2314. The bank portion 2317 suppresses leakage of a current flowing between the anode 2314 and the cathode 2316 to adjacent pixels.

A conductive pattern, an electrode of a capacitive element, and a plug are embedded in the insulating layer 14. The insulating layer 14 may be, for example, silicon oxide. Each conductive pattern may be a wiring layer. For example, as illustrated in FIG. 23, the conductive pattern includes a wiring WR1, a wiring WR2, and a wiring WR3.

A capacitive element 2305 has electrodes 2305a and 2305b, and a capacitive element 2306 has electrodes 2306a and 2306b. In the insulating layer 14, the electrodes 2305a and 2306a may be disposed on the same insulating layer. In addition, the electrodes 2305b and 2306b may be disposed on the same insulating layer. The electrodes 2305a and 2305b face each other with an insulating layer interposed therebetween. The electrodes 2306a and 2306b face each other with an insulating layer interposed therebetween. Thus, the capacitive element having a metal-insulator-metal (MIM) structure is configured.

A plurality of plugs include, for example, a plug PL1, a plug PL2, a plug PL3, a plug PL4, and a plug PL5. All of the plurality of plugs may have the same thickness, or may have different thicknesses, or some of the plugs may have the same thickness and some of the plugs may have different thicknesses.

The plug PL1 may connect the wiring WR1 and a terminal (any of a gate, a source, and a drain) of the transistor. The plug PL2 may connect the wiring WR2 and the wiring WR2. A lower electrode of the capacitive element (2305 or 2306) is connected to the drive transistor 2301 via the plug PL3, the wiring WR2, the plug PL2, the wiring WR1, and the plug PL1. In addition, an upper electrode of the capacitive element (2305 or 2306) may be connected to the wiring WR3 via the plug PL5.

The wiring WR3 is connected to the transistor (any of the drive transistor, the current control transistor, and the reset transistor in FIG. 23) via the plug PL4, the wiring R2, the plug PL2, the wiring WR1, and the plug PL1. The anode 2314 may be connected to the drain 2367 of the drive transistor 2301 via the plug PL6, the wiring WR3, the plug PL4, the wiring WR2, the plug PL2, the wiring WR1, and the plug PL1.

The plug may be made in a process separate from the wiring, and may be formed in the same process as the wiring disposed on the plug. For example, the wiring WR2 and the plug PL2 may be formed in the same process and have the same material. In addition, the wiring WR3 and the plug PL4 may be formed in the same process and have the same material. The wiring and the plug are made using a pure metal such as copper, tungsten, aluminum, and titanium, or an alloy.

In this way, by using a semiconductor substrate as the substrate and using a MOS transistor as the transistor included in each pixel, a denser arrangement can be achieved compared to a case where a thin film transistor is used as the transistor. Therefore, when the display apparatus of the first embodiment includes the semiconductor substrate and the transistor is the MOS transistor, the display apparatus can be further improved in definition or further downsized.

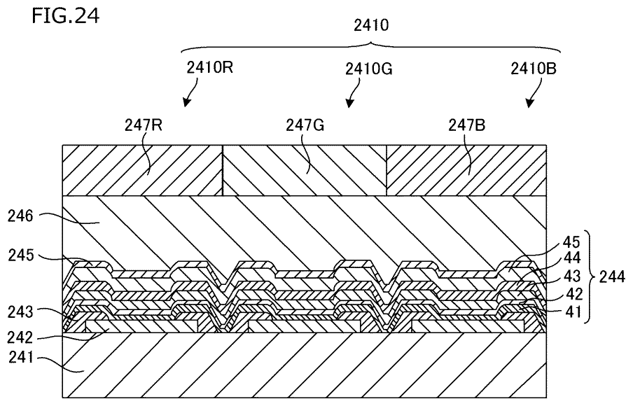

FIG. 24 is a cross-sectional schematic diagram illustrating an example of a display apparatus having organic light-emitting elements and transistors connected to respective organic light-emitting elements. The transistors are an example of active elements. Although the transistors may be thin-film transistors (TFTs) in this example, MOSFET employing a semiconductor substrate may be used for the transistors. By using MOSFETs, the transistors in each pixel can be disposed in a smaller area.

FIG. 24 is an example of a pixel, which is a constituent element of a display apparatus according to any one of the first to third embodiments. The pixel has sub-pixels 2410. The sub-pixels are divided into 2410R, 2410G and 2410B, depending on the respective emission light of the sub-pixel. The emission color may be made different on the basis of the wavelength emitted from the light-emitting layer; alternatively, the light emitted from each sub-pixel may be selectively transmitted or color-converted for instance by a respective color filter. Each sub-pixel has a reflective electrode 242 as a first electrode on an interlayer insulating layer 241, an insulating layer 243 that covers the edge of the reflective electrode 242, an organic compound layer 244 that covers a second electrode and the insulating layer, the second electrode 245, a protective layer 246, and color filters 247.

The interlayer insulating layer 241 may have transistors and capacitive elements disposed thereunder or in the interior. The transistors and the first electrode may be electrically connected for instance by way of contact holes (not shown).

The insulating layer 243 is also referred to as a bank or as pixel separation film. The insulating layer 243 is disposed covering the edge of the first electrode while surrounding the first electrode. Portions where the insulating layer is not disposed are in contact with the organic compound layer 244, yielding emission regions.

The organic compound layer 244 has a hole injection layer 41, a hole transport layer 42, a first light-emitting layer 43, a second light-emitting layer 44 and an electron transport layer 45.

The second electrode 245 may be a transparent electrode, a reflective electrode, or a semi-transparent electrode.

The protective layer 246 reduces permeation of moisture into the organic compound layer. The protective layer 246 is illustrated herein in the form of one layer, but may be multiple layers. Each protective layer 246 may have an inorganic compound layer or an organic compound layer.

The color filters 247 are divided into a color filter 247R, a color filter 247G and a color filter 247B, according to the color thereof. The color filters may be formed on a planarization film, not shown. A resin protective layer, not shown, may be provided on the color filters. The color filters may be formed on the protective layer 246. Alternatively, the color filters may be affixed after having been provided on a counter substrate such as a glass substrate.

### Third Embodiment

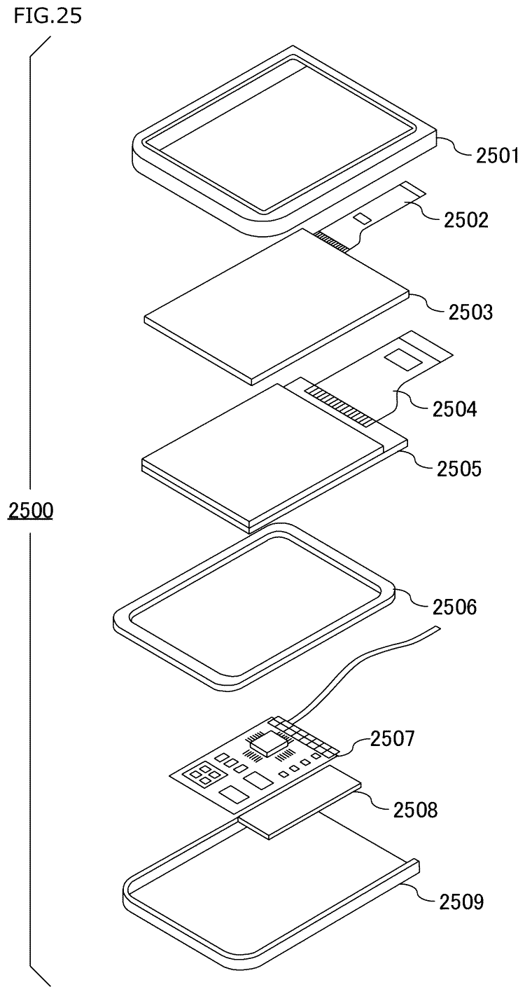

Next, FIG. 25 illustrates a schematic diagram depicting an example of a display apparatus according to the third embodiment. A display apparatus 2500 may have a touch panel 2503, a display panel 2505, a frame 2506, a circuit board 2507 and a battery 2508, between an upper cover 2501 and a lower cover 2509. The touch panel 2503 and the display panel 2505 are connected to flexible printed circuits FPCs 2502, 2504.

The display panel 2505 includes the display apparatus according to the first or second embodiment. Transistors are printed on the circuit board 2507. The battery 2508 may be omitted if the display apparatus is not a portable apparatus; even if the display apparatus is a portable apparatus, the battery 2508 may be provided at a different position.

The display apparatus 2500 may have red, green and blue color filters. The color filters may be disposed in a delta arrangement of the above red, green and blue.

The display apparatus 2500 may be used as a display unit of a mobile terminal. In that case the display apparatus 2500 may have both a display function and an operation function. Mobile terminals include mobile phones such as smartphones, tablets and head-mounted displays.

The display apparatus 2500 may be used in a display unit of an imaging apparatus that has an optical unit having a plurality of lenses, and that has an imaging element which receives light having passed through the optical unit. The imaging apparatus may have a display unit that displays information acquired by the imaging element. The display unit may be a display unit exposed outside the imaging apparatus, or may be a display unit disposed within a viewfinder. The imaging apparatus may be a digital camera or a digital video camera.

### Fourth Embodiment

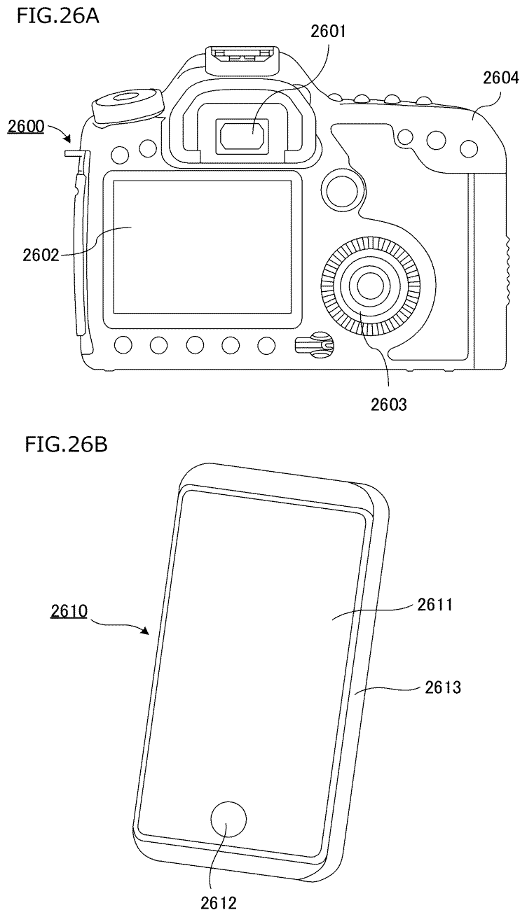

Next, FIG. 26A illustrates a schematic diagram depicting an example of an imaging apparatus according to the present embodiment. An imaging apparatus 2600 may have a viewfinder 2601, a rear display 2602, an operation unit 2603 and a housing 2604. The viewfinder 2601 may have the display apparatus according to the first or second embodiment. In that case the display apparatus may display not only an image to be captured, but also for instance environment information and imaging instructions. The environment information may include for instance external light intensity, external light orientation, the moving speed of a subject, and the chance of the subject being blocked by an obstacle.

The timing suitable for imaging is short, and hence information should be displayed as soon as possible. It is therefore preferable to configure the display apparatus so as to have high response speed, using the organic light-emitting element. A display apparatus that utilizes the organic light-emitting element can be utilized more suitably than these apparatuses or liquid crystal display apparatuses, where high display speed is required.

The imaging apparatus 2600 has an optical unit, not shown. The optical unit has a plurality of lenses, and forms an image on an imaging element accommodated in the housing 2604. The lenses can be focused through adjustment of the relative positions thereof. This operation can also be performed automatically. The imaging apparatus may be referred to as a photoelectric conversion apparatus. The photoelectric conversion apparatus can encompass, as an imaging method other than sequential imaging, a method that involves detecting a difference relative to a previous image, and a method that involves cutting out part of a recorded image.

### Fifth Embodiment

FIG. 26B is a schematic diagram illustrating an example of an electronic apparatus according to the fifth embodiment. An electronic apparatus 2610 includes a display unit 2611, an operation unit 2612, and a housing 2613. The housing 2613 may have a circuit, a printed board having the circuit, a battery, and a communication unit.

The display unit my include the display apparatus according to the first or second embodiment. The operation unit 2612 may be a button, or a touch panel-type reaction unit. The operation unit 2612 may be a biometric recognition unit which for instance performs unlocking upon recognition of a fingerprint. The electronic apparatus having a communication unit can also be referred to as a communication apparatus. The electronic apparatus 2610 may further have a camera function, by being provided with a lens and an imaging element. Images captured by way of the camera function are displayed on the display unit. Examples of the electronic apparatus include smartphones and notebook computers.

### Sixth Embodiment

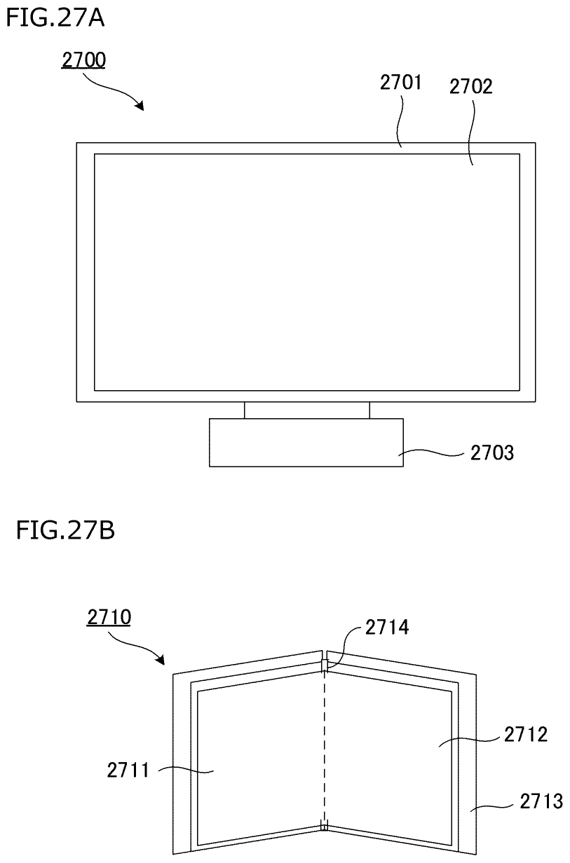

Next, FIG. 27A illustrates a schematic diagram depicting an example of an electronic apparatus according to the sixth embodiment. FIG. 27A illustrates a display apparatus 2700 such as a television monitor or PC monitor. The display apparatus 2700 has a frame 2701 and a display unit 2702. The display unit 2702 may use the display apparatus according to the first or second embodiment.

The display apparatus 2700 also has the frame 2701 and a base 2703 that supports the display unit 2702. The form of the base 2703 is not limited to the form in FIG. 27A. The lower side of the frame 2701 may also double as the base.

The frame 2701 and the display unit 2702 may be curved. The radius of curvature of the foregoing may be at least 5000 mm and not more than 6000 mm.

FIG. 27B is a schematic diagram illustrating another example of an electronic apparatus according to the sixth embodiment. A display apparatus 2710 in FIG. 27B is a so-called foldable display apparatus, configured to be foldable. The display apparatus 2710 has a first display unit 2711, a second display unit 2712, a housing 2713 and a folding point 2714. The first display unit 2711 and the second display unit 2712 may have the display apparatus according to the first or second embodiment. The first display unit 2711 and the second display unit 2712 may be one seamless display apparatus. The first display unit 2711 and the second display unit 2712 can be separated at the folding point. The first display unit 2711 and the second display unit 2712 may display different images; alternatively, the first display unit and the second display unit may display one image.

### Seventh Embodiment

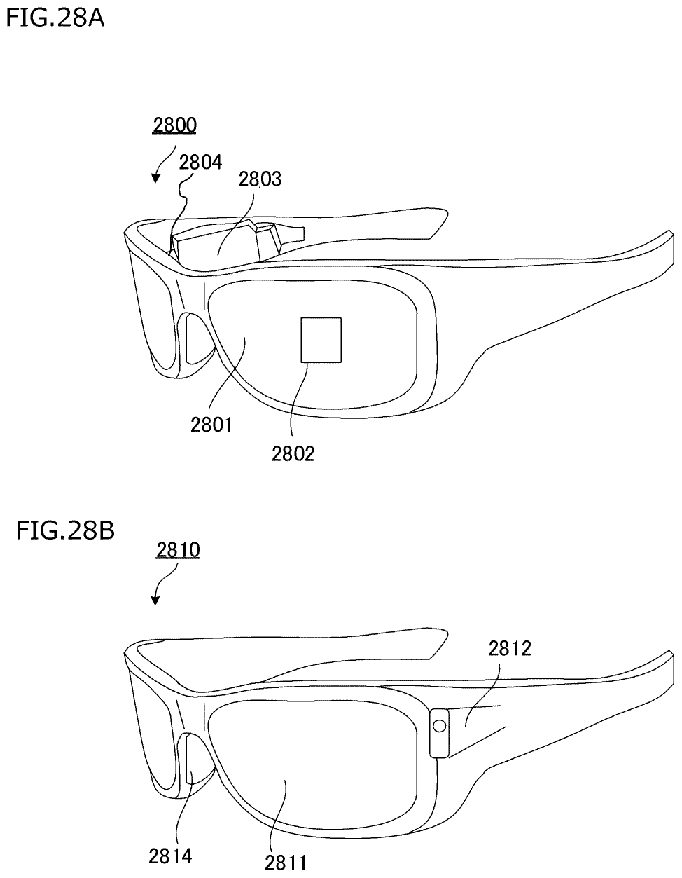

Next, application examples of the display apparatuses according to the first and second embodiments are described referring to FIGS. 28A and 28B. Display apparatuses may be applied to systems that may be worn as wearable apparatuses, such as smart glasses, HMDs, and smart contacts, for example. The imaging apparatus and display apparatus used in such application examples may be an imaging apparatus capable of photoelectrically converting visible light and a display apparatus capable of emitting visible light.

FIG. 28A illustrates spectacles 2800 (smart glasses) according to an application example of the display apparatus of the present embodiment. An imaging apparatus 2802 such as a CMOS sensor or a SPAD is provided on the front surface side of a lens 2801 of the spectacles 2800. A display apparatus 2804 according to the first or second embodiment is provided on the back surface side of the lens 2801.

The spectacles 2800 further have a control apparatus 2803. The control apparatus 2803 functions as a power supply that supplies power to the imaging apparatus 2802 and to the display apparatus 2804. The control apparatus 2803 controls the operations of the imaging apparatus 2802 and of the display apparatus 2804. The lens 2801 has formed therein an optical system for condensing light onto the imaging apparatus 2802.

FIG. 28B illustrates spectacles 2810 (smart glasses) according to another application example of the display apparatus of the present embodiment. The spectacles 2810 have a control apparatus 2812. The control apparatus 2812 has mounted therein an imaging apparatus corresponding to the imaging apparatus 2802, and a display apparatus 2814 corresponding to the display apparatus 2804. In a lens 2811 there is formed an optical system for projecting the light emitted by the display apparatus in the control apparatus 2812, such that an image is projected onto the lens 2811. The control apparatus 2812 functions as a power supply that supplies power to the imaging apparatus and to the display apparatus 2814, and controls the operations of the imaging apparatus and of the display apparatus 2814.

The control apparatus 2812 may have a line-of-sight detection unit that detects the line of sight of the wearer. Infrared rays may be used herein for line-of-sight detection. An infrared light-emitting unit emits infrared light towards one eyeball of a user who is gazing at a display image. The infrared light emitted is reflected by the eyeball, and is detected by an imaging unit having a light-receiving element, whereby a captured image of the eyeball is obtained as a result. Impairment of the appearance of the image is reduced herein by having a reducing means for reducing light from the infrared light-emitting unit to the display unit, in a plan view.

The line of sight of the user with respect to the display image is detected on the basis of the captured image of the eyeball obtained through infrared light capture. Any known method can be adopted for line-of-sight detection using the captured image of the eyeball. As an example, a line-of-sight detection method can be resorted to that utilizes Purkinje images obtained through reflection of irradiation light on the cornea.

More specifically, line-of-sight detection processing based on a pupillary-corneal reflection method is carried out herein. The line of sight of the user is detected by calculating a line-of-sight vector that represents the orientation (rotation angle) of the eyeball, on the basis of a Purkinje image and a pupil image included in the captured image of the eyeball, in accordance with a pupillary-corneal reflection method.

The spectacles 2810 may have an imaging apparatus having a light-receiving element, and may control the display image of the display apparatus on the basis of line-of-sight information about the user, from the imaging apparatus.

Specifically, a first visual field area gazed at by the user and a second visual field area, other than the first visual field area, are determined in the display apparatus 2814 on the basis of line-of-sight information. The first visual field area and the second visual field area may be determined by the control apparatus of the spectacles 2810; alternatively, the display apparatus may receive visual field areas determined by an external control apparatus. In a display area of the display apparatus 2814, the display resolution in the first visual field area may be controlled to be higher than the display resolution in the second visual field area. That is, the resolution in the second visual field area may set to be lower than that of the first visual field area.

The display area may have a first display area and a second display area different from the first display area, such that the display apparatus selects the area of higher priority, from among the first display area and the second display area, on the basis of the line-of-sight information. The first display area and the second display area may be determined by the control apparatus of the display apparatus; alternatively, the display apparatus may receive display areas determined by an external control apparatus. The display apparatus may control the resolution in a high-priority area so as to be higher than the resolution in areas other than high-priority areas. That is, the display apparatus may lower the resolution in areas of relatively low priority.

Herein AI (Artificial Intelligence) may be used to determine the first visual field area and high-priority areas. The AI may be a model constructed to estimate, from an image of the eyeball, a line-of-sight angle, and the distance to an object lying ahead in the line of sight, using training data in the form of the image of the eyeball and the direction towards which the eyeball in the image was actually gazing at. An AI program may be provided in the display apparatus, in the imaging apparatus, or in an external apparatus. In a case where an external apparatus has the AI program, the AI program is transmitted to the display apparatus via communication from the external apparatus.

In a case where the display apparatus performs display control on the basis of on visual recognition detection, the display apparatus can be preferably used in smart glasses further having an imaging apparatus that captures images of the exterior. The smart glasses can display captured external information in real time.

### Eighth Embodiment

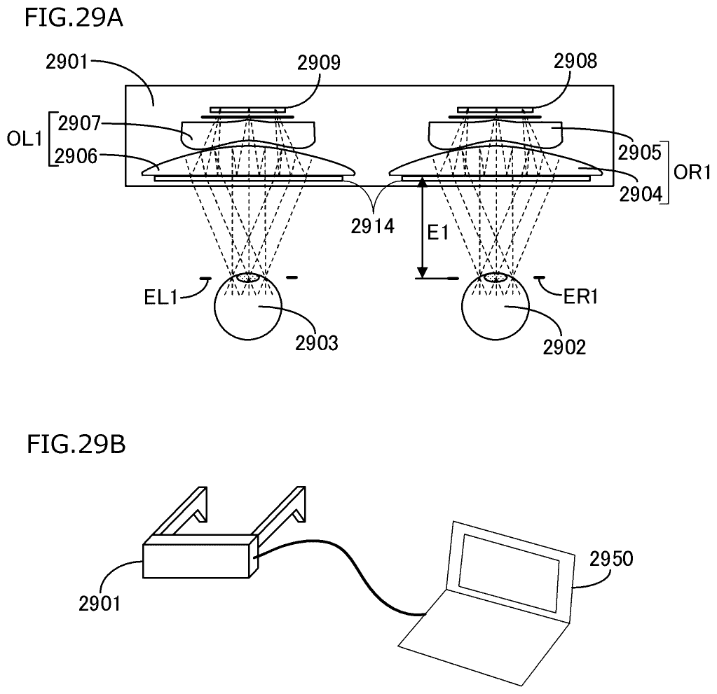

FIG. 29A is a diagram illustrating a configuration of an HMD (head mounted display) 2901 as an image observation apparatus according to the eighth embodiment. The HMD 2901 is worn on the head of the viewer. Reference numeral 2902 denotes the right eye of the observer, and reference numeral 2903 denotes the left eye of the observer. The display lenses 2904 and 2905 constitute the eyepiece optical system OR1 for the right eye, and the display lenses 2906 and 2907 constitute the eyepiece optical system OL1 for the left eye. Each eyepiece optical system is a coaxial optical system including a plurality of (two) display lenses. The right eye 2902 of the observer is disposed on the exit pupil ER1 of the right eyepiece optical system OR1, and the left eye 2903 of the observer is disposed on the exit pupil EL1 of the left eyepiece optical system OL1. The exit pupil ER1 is provided at a position away from the right eyepiece optical system OR1 by a distance E1. Similarly, the exit pupil EL1 is provided at a position away from the left eyepiece optical system OL1 by a distance E1. Optical films 2914 for lens protection, light collection, and the like are provided on the surface of the right eyepiece optical system OR1 (the surface on the right eye 2902 side) and the surface of the left eyepiece optical system OL1 (the surface on the left eye 2903 side).

Reference numerals 2908 and 2909 denote a display apparatus for the right eye and a display apparatus for the left eye, respectively. These display apparatuses may be the display apparatuses according to the first embodiment. FIG. 29B is a diagram illustrating an appearance of the HMD 2901 and a personal computer 2950 connected thereto. Each display apparatus displays a display image (original image) corresponding to an image signal output from the personal computer 2950. In the present embodiment, the connection is achieved in a wired manner, but the connection may be achieved in a wireless manner. The HMD 2901 may be a apparatus that incorporates an image processing apparatus and operates in a stand-alone mode.

The eyepiece optical systems OR1 and OL1 guide the light from the display apparatuses 2908 and 2909 to the exit pupils ER1 and EL1, respectively, thereby projecting the enlarged virtual image of the display image to the right eye 2902 and the left eye 2903 of the viewer. Accordingly, the observer can observe (virtual images of) the display images displayed on the display apparatuses 2908 and 2909 through the eyepiece optical systems OR1 and OL1.

Although not shown, the HMD 2901 may include a controller. The control apparatus functions as a power source for supplying electric power to the display apparatuses 2908 and 2909, and controls the operation of the display apparatuses 2908 and 2909.

The control apparatus may include a line-of-sight detection unit that detects a line of sight of the wearer. The gaze may be detected using infrared light. The infrared light emitting unit emits infrared light to the eyeball of the user who is gazing at the display image. A captured image of the eyeball is obtained by detecting reflected light of the emitted infrared light from the eyeball by an imaging unit having a light receiving element. The reduction unit configured to reduce light from the infrared light emitting unit to the display unit in a plan view reduces degradation in image quality.

The gaze of the user with respect to the display image is detected from the captured image of the eyeball obtained by capturing the infrared light. Any known technique may be applied to the gaze detection using the captured image of the eyeball. As an example, a gaze detection method based on a Purkinje image due to reflection of irradiation light on the cornea can be used.

More specifically, the line-of-sight detection process based on the pupillary corneal reflection method is performed. The gaze of the user is detected by calculating a gaze vector representing the orientation (rotation angle) of the eyeball based on the image of the pupil included in the captured image of the eyeball and the Purkinje image using the pupil corneal reflex method.

Specifically, the display apparatuses 2908 and 2909 determine a first display region to be gazed by the user and a second display region other than the first display region based on the line-of-sight information. The first display region and the second display region may be determined by the control apparatus, or may be received by an external control apparatus. In the display regions of the display apparatuses 2908 and 2909, the display resolution of the first display region may be controlled to be higher than the display resolution of the second display region. That is, the resolution of the second display region may be lower than that of the first visibility region.

The display region includes a first display region and a second display region different from the first display region, and a region with a higher priority is determined from the first display region and the second display region based on the line-of-sight information. The first display region and the second display region may be determined by a control apparatus of the display apparatus, or may be received by an external control apparatus. The resolution of the high priority region may be controlled to be higher than the resolution of the region other than the high priority region. That is, the resolution of the region having a relatively low priority may be lowered.

Note that the AI may be used to determine the first display region or the region with high priority. The AI may be a model configured to estimate the angle of the line of sight and the distance to the target object ahead of the line of sight from the image of the eyeball using the image of the eyeball and the direction in which the eyeball of the image is actually viewed as teacher data. The AI program may be included in the display apparatus, the imaging apparatus, or the external apparatus. In a case where the external apparatus has the information, the information is transmitted to the display apparatus via communication.

As described above, the display apparatus according to any one of the first to third embodiments may be applied to various photoelectric conversion apparatus products, electronic apparatuses, and the like according to the present embodiment.

The embodiments described above may be appropriately modified without departing from the technical idea. Note that the disclosure of the present specification includes not only the matters described in the present specification but also all matters that may be grasped from the present specification and the drawings attached to the present specification.

According to the present invention, by temporally uniformizing the light emission area of the display region, it is possible to suppress the temporal deviation of the amount of current flowing through the light emitting element and to suppress degradation in the display quality.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-073803, filed on Apr. 30, 2024, which is hereby incorporated by reference herein in its entirety.

What is claimed is:

1. A display apparatus comprising:
a display area including a plurality of pixels arranged in a matrix, the pixels each including a light emitting element, a write control transistor for writing a signal voltage to the light emitting element, a light emission control transistor for causing the light emitting element to emit light, and a drive transistor for driving the light emitting element;
a first selection line which is provided for each row of the plurality of pixels and connected to the write control transistors of the pixels arranged in a row direction;
a second selection line which is provided for each row of the plurality of pixels and connected to the light emission control transistors of the pixels arranged in the row direction;
a first scanning circuit which scans a plurality of the first selection lines in sequence; and
a second scanning circuit which scans a plurality of the second selection lines in sequence, wherein
image data is displayed in the display area,
the image data is divided into a plurality of regions having different resolutions, and the plurality of regions are arranged such that at least two regions are included in a column direction,
a speed of scanning by the first scanning circuit is different for each of the regions arranged in the column direction, and
a speed of scanning by the second scanning circuit is at least a lowest speed of the speed of scanning by the first scanning circuit and less than a maximum speed thereof.

2. The display apparatus according to claim 1, wherein the speed of scanning by the second scanning circuit over the plurality of regions is constant.

3. The display apparatus according to claim 1, wherein one frame period for display of the image data in the display area is determined according to a time required for one scan of the plurality of regions by the first scanning circuit.

4. The display apparatus according to claim 1, wherein one frame period for display of the image data in the display area is determined according to a time required for one scan of the plurality of regions by the second scanning circuit.

5. The display apparatus according to claim 1, wherein a time required for one scan of the plurality of regions by the first scanning circuit and a time required for one scan of the plurality of regions by the second scanning circuit are the same.

6. The display apparatus according to claim 1, wherein the plurality of pixels in the display area are uniform in size.

7. The display apparatus according to claim 1, wherein sizes of the plurality of pixels differ for each region of a specific resolution in the plurality of regions.

8. The display apparatus according to claim 7, wherein the scanning by the second scanning circuit is performed such that an amount of light emission of the pixel in a region of a relatively high resolution among the plurality of regions is determined in accordance with the size of the pixel in a region of a relatively low resolution among the plurality of regions.

9. The display apparatus according to claim 7, wherein the scanning by the second scanning circuit is performed such that an amount of light emission of the pixel in a region of a relatively low resolution among the plurality of regions is determined in accordance with the size of the pixel in a region of a relatively high resolution among the plurality of regions.

10. A photoelectric conversion apparatus comprising:
an optical unit;
an imaging element which receives light that has passed through the optical unit; and
a display apparatus which displays an image captured by the imaging element, wherein
the display apparatus is the display apparatus according to claim 1.

11. An electronic apparatus comprising:
the display apparatus according to claim 1;
a housing in which the display apparatus is provided; and
a communication unit which is provided in the housing and communicates with an outside.
